(19) United States
(12) Patent Application Publication
(10) Pub. No.: US 2026/0282173 A1
(43) Pub. Date: Sep. 17, 2026

(54) HEATER ASSEMBLY COMPRISING THERMALLY INSULATING LAYER

(71) Applicant: Philip Morris Products S.A., Neuchatel (CH)

(72) Inventors: Jérôme Christian COURBAT, Cortaillod (CH); Leander DITTMANN, Crissier (CH); Ross Peter JONES, Cambridge (GB)

(73) Assignee: Philip Morris Products S.A., Neuchatel (CH)

(21) Appl. No.: 19/168,098

(22) PCT Filed: Mar. 28, 2024
(86) PCT No.: PCT/EP2024/058646

§ 371 Date: Sep. 23, 2025

(30) Foreign Application Priority Data
Mar. 29, 2023 (EP) 23165195.1

(51) Int. Cl. H05B 3/26; A24F 40/10; A24F 40/46; H05B 3/16

(52) U.S. Cl. CPC H05B 3/265; A24F 40/10; A24F 40/46; H05B 3/16; H05B 3/267; H05B 2203/021

(57) ABSTRACT

A heater assembly for an aerosol-generating device is provided, the heater assembly including: a heating element configured to vaporise a liquid aerosol-forming substrate; a porous body configured to convey the liquid aerosol-forming substrate to the heating element; and a thermally insulating layer having a lower thermal conductivity than the porous body, the thermally insulating layer being disposed between and being in contact with each of the porous body and the heating element, and the thermally insulating layer being configured to reduce heat transfer from the heating element to the porous body, the porous body including a porous ceramic body or a porous glass body, and the heating element forming a film across the thermally insulating layer.

The present disclosure relates to a heater assembly for an aerosol-generating device. In particular, but not exclusively, the present disclosure relates to a heater assembly for a handheld electrically operated aerosol-generating device for heating an aerosol-forming substrate to generate an aerosol and for delivering the aerosol into the mouth of a user. The present disclosure further relates to a device comprising a heater assembly, and to a cartridge comprising a heater assembly.

Aerosol-generating systems that heat a liquid aerosol-forming substrate in order to generate an aerosol for delivery to a user are generally known in the prior art. These systems typically comprise an aerosol-generating device and a reservoir attached to the device, or a replaceable cartridge. The reservoir includes a liquid aerosol-forming substrate that is capable of releasing volatile compounds when heated. The device typically also includes a heater for heating the liquid aerosol-forming substrate. In known aerosol-generating systems, the heater comprises a resistive heating element wound around a wick that supplies liquid aerosol-forming substrate to the heating element. The aerosol-generating device or cartridge also comprises a mouthpiece. When a negative pressure is applied at the mouthpiece, an electric current is passed through the heating element causing it to be heated by resistive or Joule heating, which, in turn, heats the liquid aerosol-forming substrate supplied by the wick. This causes volatile compounds to be released from the liquid aerosol-forming substrate that cool to form an aerosol. The aerosol is then drawn into a user's mouth via the mouthpiece.

Such known aerosol-generating systems have a number of drawbacks. For example, they can be difficult to manufacture with consistent manufacturing tolerances which can result in inconsistent vapour production and flavour generation. Inconsistent manufacturing tolerances can also affect the transfer of heat from the heating element to the wick reducing the energy efficiencies of such devices. They can also experience “dry heating” or a “dry puff”, which arises when the heating element is heated with insufficient liquid aerosol-forming substrate being supplied to the heating element which can result in a poor user experience.

One known aerosol-generating system has a ceramic body and a heating element, to which power is supplied through electrical contacts. Liquid is supplied from a liquid reservoir to the heating element via pores within the ceramic body. In this known aerosol-generating system, thermal inefficiency arises from energy losses of the heating element. In this system, energy is lost from the heating element to the ceramic body and to the liquid within the ceramic body. These energy losses increase the energy required during use. These energy losses also reduce the amount the device can be used until a battery of the device needs to be recharged or replaced.

It would be desirable to provide a more energy efficient heater assembly. It would be desirable to provide a heater assembly that increases the amount the device can be used before a battery needs to be re-charged or replaced.

According to an example of the present disclosure, there is provided a heater assembly for an aerosol-generating device. The heater assembly may comprise a heating element for vaporising a liquid aerosol-forming substrate. The heater assembly may comprise a porous body for conveying the liquid aerosol-forming substrate to the heating element. The heater assembly may comprise a thermally insulating layer. The thermally insulating layer may have a lower thermal conductivity than the porous body. The thermally insulating layer may be disposed between each of the porous body and the heating element. The thermally insulating layer may be in contact with each of the porous body and the heating element. The thermally insulating layer may be configured to reduce heat transfer from the heating element to the porous body. The porous body may comprise a porous ceramic body or a porous glass body.

According to an example of the present disclosure, there is provided a heater assembly for an aerosol-generating device. The heater assembly comprises a heating element for vaporising a liquid aerosol-forming substrate. The heater assembly comprises a porous body for conveying the liquid aerosol-forming substrate to the heating element. The heater assembly comprises a thermally insulating layer having a lower thermal conductivity than the porous body. The thermally insulating layer is disposed between each of the porous body and the heating element. The thermally insulating layer is in contact with each of the porous body and the heating element. The thermally insulating layer is configured to reduce heat transfer from the heating element to the porous body. The porous body comprises a porous ceramic body or a porous glass body.

With this arrangement, the heat losses from the heating element to the porous body, and to liquid within the porous body, are reduced. This provides a more efficient heater assembly in which the amount of use and number of uses of the device by a user can be increased, before the device power supply, such as a battery, is depleted. The inventors have estimated that in a known device, approximately one third of energy from the heating element is lost through conduction in the porous body and liquid in the porous body. The remaining two thirds are used to generate an aerosol by heating a liquid aerosol-forming substrate. In the arrangement described herein, these energy losses are reduced. Specifically, the thermally insulting layer reduces heat propagation or conduction from the heating element towards or through the porous body. This reduction in conduction can concentrate heat to a heating surface of the porous body, minimising heat dissipation and increasing heating efficiency of the heater assembly.

As used herein, the term “aerosol-generating device” relates to a device that interacts with a liquid aerosol-forming substrate to generate an aerosol.

As used herein, the terms “cartridge” and “aerosol-generating cartridge” relate to a component that interacts with a liquid aerosol-forming device to generate an aerosol. An aerosol-generating cartridge contains, or is configured to contain, a liquid aerosol-forming substrate.

As used herein, the term “liquid aerosol-forming substrate” relates to a liquid substrate capable of releasing volatile compounds that can form an aerosol. Such volatile compounds can be released by heating the aerosol-forming substrate.

As used herein, the term “porous” refers to a component which has a plurality of pores. At least some of the pores are open-cell pores. At least some of the pores are interconnected such that liquid can pass through the porous component.

As used herein, the term “porous body” refers to a component which has a plurality of pores. At least some of the pores are open-cell pores. At least some of the pores are interconnected such that liquid can pass through the porous component. The porous body is configured to contain liquid within the plurality of pores.

As used herein, the term “heating element” refers to a component which transfers heat energy to the liquid aerosol-forming substrate.

As used herein, the term “thermally insulating” refers to a property in which heat transfer is reduced or restricted. A more thermally insulating component will transfer less heat, via conduction, convection or radiation, than a more thermally insulating component.

The heating element may form a film across the thermally insulating layer.

The thermally insulating layer may comprise a thermally insulating material. The thermally insulating material may have a lower thermal conductivity than the porous body. The thermally insulating material may have a higher porosity than the porous body. This has the advantage of providing a thermally insulating layer which is particularly effective at reducing energy losses, while being easy to manufacture.

The thermally insulating layer may comprise a material having a thermal conductivity of less than 40 Watts per metre-Kelvin. This has the advantage of providing a thermally insulating layer which is effective at reducing energy losses through the porous body. The thermally insulating layer may comprise a material having a thermal conductivity of less than 10 Watts per metre-Kelvin. This has the advantage of providing a thermally insulating layer which is particularly effective at reducing energy losses through the porous body.

The thermally insulating layer may extend entirely between the porous body and the heating element. This has the advantage of more effectively providing a barrier between the heating element and the porous body, and as such is particularly effective at reducing energy losses through the porous body.

The thermally insulating layer may comprise one or more of: alumina, zirconia, zirconia with magnesium oxide, glass ceramic, quartz, a porous polymer. The porous polymer may be polyimide.

The thermally insulating layer may comprise alumina having a thermal conductivity of 20-40 Watts per metre-Kelvin. The thermally insulating layer may comprise a material having a thermal conductivity of less than 10 Watts per metre-Kelvin, such as zirconia with or without magnesium oxide, glass ceramics, quartz. Use of alumina, zirconia with or without magnesium oxide, glass ceramics, quartz, is advantageous, as these materials are compatible with a manufacturing process involving sintering, and as such a heater assembly having a thermally insulating layer of one of these materials is more easily manufactured.

The thermally insulating layer may have a thickness of between 0.1 mm and 2 mm. A thermally insulating layer with such a thickness is particularly suited to reducing energy losses from the heating element to the porous ceramic body. Preferably, the thermally insulating layer has a thickness of between 0.5 mm and 1.5 mm. A thermally insulating layer with such a thickness is further suited to reducing energy losses from the heating element to the porous ceramic body.

The porous body may comprise a porous ceramic body or a porous glass body. The porous body may comprise a porous material having open-cell pores. The plurality of open-cell pores may be interconnected to provide a fluid pathway for aerosol-generating liquid through the porous body. The porous body may comprise a material which does not chemically interact with the liquid aerosol-forming substrate. The porous material may have a porosity of between 20 percent and 80 percent. The porous body may have a flat surface or a curved surface. The porous body may have a geometrical shape. The porous body may be in the shape of a cube or a cuboid, or it may have a shape of a disc or a cylinder, or a combination of any of these shapes. The porous body may comprise or consist of a material with a low thermal conductivity. The porous body may comprise or consist of non-electrically conductive material. The porous body may comprise a polymeric or a ceramic material. The porous body may comprise cotton. The porous body may comprise porous ceramic, such as but not limited to Al₂O₃, ZrO₂, Si₃N₄, SiC, Ti₃AlC₂, BN, AlN, SiO₂, MgO, mica, diatomite, silicates, silicides, borides, glass, or a combination of any of these materials. The porous body may comprise aluminium nitride or silicon carbide. Aluminium nitride and silicon carbide typically have a relatively high thermal conductivity, of approximately 100-200 Watts per metre-Kelvin. In a sintered form, aluminium nitride and silicon carbide can have a thermal conductivity of less than 100 Watts per metre-Kelvin.

The porous body may be composed of a monolithic material or of a hybrid material. The porous body may be constructed of different parts attached to each other. These different parts may comprise or consist of different materials and may have different morphology and topology and properties. The porous body may have a thickness such that heat losses through conduction to the reservoir of liquid are negligible. The porous body may have a thickness which depends on the thermal properties of the material it is made from and the liquid it contains. The porous body may have a thickness between 0.5 mm and 10 mm. The porous body may comprise an electrically insulating material.

The heating element may be disposed on the thermally insulating layer. The heating element may be attached to the thermally insulating layer. The heating element may be attached to the porous body by the thermally insulating layer. The heating element may be attached to the porous body with the thermally insulating layer between the heating element and the porous body. The heating element may comprise or consist of an electrically conductive material. The heating element may comprise or consist of a metal, such as but not limited to stainless steel, Ni—Cr alloy, NiCrAlY alloy, FeCrAl alloys (e.g., “Kanthal”), FeCrAlY alloys, Fe₃Al alloy, Ni₃Al alloy, NiAl alloy, and CuNi alloys. The heating element comprise or consist of an electroceramic, such as but not limited to MoSi₂, doped SiC, Indium Tin Oxide (ITO), lanthanum-doped strontium titanate (SLT), yttrium-doped strontium titanate or a combination of any of these materials. The heating element may comprise an impermeable material. When supplied with electricity, the heating element may generate heat by Joule effect heating.

The heating element may be deposited or patterned by thick film techniques such as screen-printing, inkjet-printing, aerosol jet printing, LDS (Laser Direct Structuring). The heating element may be deposited or patterned by thin film techniques such as PVD (Physical Vapor Deposition, e.g., evaporation, sputtering) or CVD (Chemical Vapor Deposition), or similar. The heating element resistance at room temperature may be between 0.5 Ohms and 1.5 Ohms, between 0.7 Ohms and 1.3 Ohms, or preferably 1 Ohm.

The heating element may be a porous heating element.

The heating element may extend to cover an area of the heating surface of the thermally insulating layer. The heating element may extend to cover a substantial area of the heating surface of the thermally insulating layer. The heating element may extend to cover at least half of the heating surface of the thermally insulating layer. Preferably, the heating element extends to cover at least two thirds of the heating surface of the thermally insulating layer. More preferably the heating element extends to cover at least three quarters of the heating surface of the thermally insulating layer. More preferably the heating element extends to cover all of the heating surface of the thermally insulating layer.

A template may be added into the heating element material that is removed by sintering to form a porous structure, to enhance liquid vaporization. The heating element may have a microstructure indicative of having been manufactured with a template, the template having been removed by sintering to form a porous structure.

The heating element may be disposed on at least one face of the porous body. The heating element may cover at least one face of the porous body. The heating element may wrap the porous body. The porous heating element may be planar, or may have any suitable shape.

In a known serpentine heating element, failure initiation of the serpentine heater track involves an increase of local resistance. In a serpentine heating element, a local resistance increase results in increased power dissipation, further increasing the resistance until breakage, i.e., forming a positive feedback loop. A porous layer avoids this effect by allowing the current flow to redistribute and avoid a region or regions of increased resistance. A porous heating element which extends over the thermally insulating layer is particularly advantageous.

A heater assembly having a thermally insulating layer combined with a porous heating element is particularly advantageous. Such a combination is particularly advantageous where the porous heating element extends to cover all of the heating surface of the porous body, and by doing so covers the thermally insulating layer. In such a case, low thermal conduction into the porous body can be achieved, which reduces thermal losses, while maintaining consistent heating of the aerosol-forming substrate. In contrast, if a track type heater, such as a serpentine or an electrically parallel track heating element, is combined with the thermally insulating layer, then a higher in-plane thermal conductivity of the thermally insulating layer is required to allow heat to spread between the heater tracks to have uniform heating. However, a lower thermal conductivity of the thermally insulating layer reduces energy losses through the porous body. The porous heating element may extend so as to only partially cover a heating surface of the porous body. This has the advantage of increased power density.

A heater assembly having a thermally insulating layer and a porous heating element is particularly advantageous because this combination allows heat to be concentrated along the heating element and heat flow and dissipation into the porous body to be limited.

The heating element may comprise a track. The track may define a path across the heating surface of the thermally insulating layer. The track may define a serpentine path across the heating surface of the thermally insulating layer.

The heating element may comprise a plurality of tracks or track portions arranged with a distance between at least two of the plurality of tracks or track portions in the range 150 to 300 micrometres. All of the tracks or track portions may be spaced apart from at least one other track portion by 150 to 300 micrometres. This has the advantage of providing a particularly efficient heater assembly, in which an aerosol-forming substrate is efficiently vaporised.

The heating element may be disposed on at least one face of the porous body. The heating element may cover at least one face of the porous body. The heating element may wrap the porous body. The heating element may comprise a resistive track. When supplied with electricity, the resistive track may generate heat by Joule effect heating. The resistive track may have any suitable shape, including but not limited to a serpentine shape, a meander shape, a spiral shape, a plurality of parallel tracks.

The heating element may have a depth of at most 250 micrometres. The heating element may have a depth in the range of 0.5 micrometres to 250 micrometres. The heating element may have a depth in the range of 50 micrometres to 250 micrometres. The heating element may have a depth in the range of 5 micrometres to 50 micrometres. The heating element may have a depth in the range of 0.5 micrometres to 10 micrometres. The heating element may have a microstructure indicative of having been: etched from a foil; screen-printed; or deposited by a thin-film deposition method.

When supplied with electricity, heat losses by thermal conduction occur through the porous body. A heating element comprising a track is advantageous as thermal losses are proportional to the heated area. The track may be disposed on a surface or part of a surface of the porous body. The heating element may have a surface area of less than a half, preferably less than a third, preferably less than a quarter, preferably less than a tenth of the area of the heating surface of the porous body, to increase power density when supplied with power. An increase in power density increases the throughput of liquid to be vaporized, reduces the time to reach boiling and increases thermal efficiency (by increasing the ratio of power used for vaporization to power lost in the porous body). The power density may be increased by reducing the width of the heater track. The power density may be increased by reducing the gap between tracks of the heating element. In a heater assembly having a thermally insulating layer, a distance between at least two of the plurality of tracks or track portions in the range 150 to 300 micrometres is particularly advantageous.

The heating element may comprise a plurality of tracks or track portions arranged electrically in parallel. The heating element resistance at room temperature may be between 0.5 Ohms and 1.5 Ohms, preferably between 0.7 Ohms and 1.3 Ohms, and more preferably 1 Ohm. The resistance of the heating element may be matched to requirements of control electronics.

At least two of the electrically parallel heating tracks may have similar resistances to each other, or have the same resistance as each other. Preferably, all of the electrically parallel heating tracks are of similar or of the same resistance as each other. The heating tracks arranged electrically in parallel may have different resistances, which is particularly beneficial in a heater assembly where it is advantageous for zones of the heating element to generate different power levels. This could be the case, for example, to compensate for higher thermal losses in an outer part of the heating element. As such, heating tracks on an exterior or outer part of the heating element may be designed to have a lower resistance (which can generate more heat) than heating tracks in the centre of the heating element.

The heating element may comprise a plurality of tracks or track portions defining a path having at least one bend, the inner edge of the bend being curved.

The inner edge of the bend being curved has the advantage of guiding current to flow in a more evenly distributed way around the at least one bend. This reduces a current concentration which in turn limits hot spot creation.

The heating element may comprise a plurality of tracks or track portions having a gradient of electrical resistivity perpendicular to current flow in a corner or corners, such that the electrical resistivity is higher at an inner part of the corner and lower at an outer part of the corner. Such a gradient is beneficial to counterbalance localized high current density and reduce hot spot creation.

According to an example of the present disclosure, there is provided a cartridge. The cartridge may comprise a heater assembly. The cartridge may comprise a liquid storage portion for holding an aerosol-forming substrate. The heater assembly may comprise a heating element for vaporising the liquid aerosol-forming substrate. The heater assembly may comprise a porous body for conveying the liquid aerosol-forming substrate to the heating element. The heater assembly may comprise a thermally insulating layer having a lower thermal conductivity than the porous body. The thermally insulating layer may be disposed between each of the porous body and the heating element. The thermally insulating layer may be in contact with each of the porous body and the heating element. The thermally insulating layer may be configured to reduce heat transfer from the heating element to the porous body. The porous body may comprise a porous ceramic body or a porous glass body.

According to an example of the present disclosure, there is provided a cartridge, the cartridge comprising a heater assembly and a liquid storage portion for holding a liquid aerosol-forming substrate, the heater assembly comprising: a heating element for vaporising the liquid aerosol-forming substrate; a porous body for conveying the liquid aerosol-forming substrate to the heating element; and a thermally insulating layer having a lower thermal conductivity than the porous body, wherein the thermally insulating layer is disposed between and is in contact with each of the porous body and the heating element, and the thermally insulating layer is configured to reduce heat transfer from the heating element to the porous body.

The cartridge may comprise the liquid aerosol-forming substrate in the liquid storage portion. The liquid aerosol-forming substrate may be as described above.

The porous body may be fluidly connected to the liquid storage portion. The porous body may have a liquid absorption surface. The liquid absorption surface of the porous body may be fluidly connected to the liquid storage portion.

The liquid storage portion may be arranged at the liquid absorption surface of the porous body.

There is provided an aerosol-generating system. The aerosol-generating system may comprise a cartridge and an aerosol-generating device. The cartridge may comprise a heater assembly. The cartridge may comprise a liquid storage portion for holding an aerosol-forming substrate. The heater assembly may comprise a heating element for vaporising the liquid aerosol-forming substrate. The heater assembly may comprise a porous body for conveying the liquid aerosol-forming substrate to the heating element. The heater assembly may comprise a thermally insulating layer having a lower thermal conductivity than the porous body. The thermally insulating layer may be disposed between each of the porous body and the heating element. The thermally insulating layer may be in contact with each of the porous body and the heating element. The thermally insulating layer may be configured to reduce heat transfer from the heating element to the porous body. The porous body may comprise a porous ceramic body or a porous glass body. The aerosol-generating device may comprise a power supply for supplying electrical power to the heating element. The aerosol-generating device may comprise control circuitry configured to control a supply of power from the power supply to the heating element.

There is provided an aerosol-generating system comprising: a cartridge and an aerosol-generating device, the cartridge comprising a heater assembly and a liquid storage portion for holding a liquid aerosol-forming substrate, the heater assembly comprising: a heating element for vaporising the liquid aerosol-forming substrate; a porous body for conveying the liquid aerosol-forming substrate to the heating element; and a thermally insulating layer having a lower thermal conductivity than the porous body, wherein the thermally insulating layer is disposed between and is in contact with each of the porous body and the heating element, and the thermally insulating layer is configured to reduce heat transfer from the heating element to the porous body. The aerosol-generating device may comprise a power supply for supplying electrical power to the heating element; and control circuitry configured to control a supply of power from the power supply to the heating element.

The cartridge may comprise the liquid aerosol-forming substrate in the liquid storage portion. The liquid aerosol-forming substrate may be as described above.

The aerosol-generating system may be portable. The aerosol-generating system may have a size comparable to a conventional cigar or cigarette.

The cartridge may be removably couplable to the aerosol-generating device.

The aerosol-forming substrate may be liquid at room temperature. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5% and about 10%, for example about 2%.

The airflow pathway may pass through the liquid storage portion. For example, the liquid storage portion may have an annular cross-section defining an internal passage or aerosol channel, and the airflow pathway may extend through the internal passage or aerosol channel of the liquid storage portion.

The cartridge may comprise a cartridge housing. The cartridge housing may be formed from a durable material. The cartridge housing may be formed from a liquid impermeable material. The cartridge housing may be formed form a mouldable plastics material, such as polypropylene (PP) or polyethylene terephthalate (PET) or a copolymer such as Tritan™, which is made from three monomers: dimethyl terephthalate (DMT), cyclohexanedimethanol (CHDM), and 2,2,4,4-tetramethyl-1,3-cyclobutanediol (CBDO). The cartridge housing may define a portion of the liquid storage portion or reservoir. The cartridge housing may define the liquid storage portion. The cartridge housing and the liquid storage portion may be integrally formed. Alternatively, the liquid storage portion may be formed separately from the outer housing and arranged in the outer housing.

The aerosol-generating device may comprise a power supply for supplying power to the heater assembly. The aerosol-generating device may comprise control circuitry for controlling the supply of power from the power supply to the heater assembly. The cartridge may be removably couplable to the aerosol-generating device.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device housing may define a cavity for receiving a portion of a cartridge. The aerosol-generating device may have a connection end configured to connect the aerosol-generating device to a cartridge. The connection end may comprise the cavity for receiving the cartridge.

The power supply may be any suitable power supply. Preferably, the power supply is a DC power supply. The power supply may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power supply may be another form of charge storage device such as a capacitor. The power supply may be rechargeable and be configured for many cycles of charge and discharge. The power supply may have a capacity that allows for the storage of enough energy for one or more user experiences of the aerosol-generating system; for example, the power supply may have sufficient capacity to allow for the continuous generation of aerosol for a period of around six minutes, corresponding to the typical time taken to smoke a conventional cigarette, or for a period that is a multiple of six minutes. In another example, the power supply may have sufficient capacity to allow for a predetermined number of puffs or discrete activations of the aerosol-generating system.

The control circuitry may comprise any suitable controller or electrical components. The controller may comprise a memory. Information for performing a method of operation of the device or system may be stored in the memory. The control circuitry may comprise a microprocessor. The microprocessor may be a programmable microprocessor, a microcontroller, or an application specific integrated chip (ASIC) or other electronic circuitry capable of providing control. The control circuitry may be configured to supply power to the heating element continuously following activation of the device, or may be configured to supply power intermittently, such as on a puff-by-puff basis. The power may be supplied to the heating element in the form of pulses of electrical current, for example, by means of pulse width modulation (PWM).

Features described in relation to one of the above examples may equally be applied to other examples of the present disclosure.

The heating element may comprise a plurality of tracks or track portions. The plurality of tracks or track portions may be arranged electrically in parallel. By being arranged electrically in parallel, current flow is split into separate parallel flow paths, the separate parallel flow paths being subsequently re-combined.

The heating element may comprise a first connecting pad and a second connecting pad. The first or second connecting pads (or first and second connecting pads) may be configured to allow connection to an external circuit. An aperture or plurality of apertures in the heating element may separate each track or track portion. The heating element may comprise at least one diverging portion, in which current is split from the first connecting pad into track portions. The track portions define electrically parallel paths. The heating element may comprise a converging portion. In the converging portion, current is combined from track portions which define electrically parallel paths, into the second connecting pad.

Various different arrangements are possible of tracks or track portions arranged electrically in parallel. The heating element may comprise two, three, four or more track portions which define electrically parallel paths.

By having tracks or track portions arranged electrically in parallel, if one track portion is defective, current can be redistributed and can still flow through the heating element, i.e. the electrical connection between the first connecting pad and the second connecting pad is not broken. In contrast, in a simple serpentine heater defining a single electrical path between the first connecting pad and the second connecting pad, if a part of the serpentine heating element is broken or contains a defect, this can cause an increase in local resistance, causing increased power dissipation, which in turn increases the resistance until breakage.

The inventors have also identified that the electrically parallel tracks or track portions have a surprising additional advantage. In such an arrangement, in case of breakage of one track portion, the heating element will still operate and can, for an initial transitory period, operate in an advantageous way because the breakage of one track or track portion would result in a higher energy density on the remaining tracks or track portions. In such a case, the same power would still be provided but over a smaller area, so throughput of the aerosol-forming substrate is increased. Such a breakage causing an increase in current on unbroken tracks or track portions can eventually affect the user's experience. This can be mitigated for by a mechanism to alert the user about possible future below optimal performance of the heater assembly. Electrically parallel tracks have the advantage of increasing the number of puffs before full failure of the heater, and potentially increasing the heater lifetime up to the lifetime of the device.

According to an example of the present disclosure, there is provided a ceramic heating member for an aerosol-generating system. The ceramic heating member may comprise a heating portion for vaporising a liquid aerosol-forming substrate. The ceramic heating member may comprise a porous portion for conveying the liquid aerosol-forming substrate to the heating portion. The heating portion and the porous portion may be integrally formed. A thermally insulating layer may be disposed between the heating portion and the porous portion.

According to an example of the present disclosure, there is provided a ceramic heating member for an aerosol-generating system. The ceramic heating member comprises a heating portion for vaporising a liquid aerosol-forming substrate. The ceramic heating member comprises a porous portion for conveying the liquid aerosol-forming substrate to the heating portion. The heating portion and the porous portion are integrally formed. A thermally insulating layer is disposed between the heating portion and the porous portion.

The ceramic heating member of this example provides an improved component for an aerosol-generating system. By providing a ceramic heating member in which a heating portion, for vaporising a liquid aerosol-forming substrate, and a porous portion, for conveying the liquid aerosol-forming substrate, are integrally formed, a more robust and reliable connection can be established between the heating portion and the porous portion. This may advantageously help to improve the transfer of heat between the heating portion and the porous portion.

Forming the heating portion integrally with the porous portion may also advantageously provide a heating member which is easier to reliably manufacture, thus resulting in a more energy efficient heating member capable of generating a more consistent aerosol. This, in turn, may provide a user of the aerosol-generating system with an improved and more enjoyable experience. Such an arrangement may also help to reduce the likelihood of a user experiencing dry heating or a dry puff.

An advantage of forming the heating portion integrally with the porous portion is that it helps to alleviate the problems of manufacturing tolerances encountered with wick and coil heaters and other arrangements in which a heating element is detached from a liquid transport element. The dimensions and arrangement of the electrical heating portion relative to the porous portion are also fixed, which helps to produce a more consistent aerosol. This is because the electrical heating portion is fixed to the porous portion, which helps to supply liquid aerosol-forming substrate to the heating element. This also helps to prevent unwanted loss of heat, which helps to improve energy efficiency.

By forming the heating portion integrally with the porous portion, the resulting aerosol-generating system may benefit from reduced material requirements. This is because the need for intermediate components which fix the heating portion relative to the porous portion can be reduced or eliminated entirely. The material savings can result in cost savings of the overall aerosol-generating system. An additional advantage of the reduced material requirements in the overall aerosol-generating system is the provision of a more sustainable and environmentally friendly solution.

Such a ceramic heating member may also be advantageous in that the risk of the heating portion and the porous portion becoming detached is greatly reduced.

The heating element, the thermally insulating layer and the porous body may be moulded as a single monolithic piece.

This may help to simplify the manufacturing of the heater assembly by reducing manufacturing times and providing a more cost effective solution. This may advantageously create a tight mechanical connection between the heating element, the thermally insulating layer and the porous body.

The heating element may be a doped portion of the porous body.

The porous body may be doped such that the portion of the porous body which acts as the heating element is electrically conductive. Doping the porous body to provide the heating element may be advantageous in that it avoids altering the porosity of the porous body. This may be preferable to other known techniques of forming a heating element, which involve depositing the heating element by thin film or thick film techniques, which can reduce the properties of the porous body, in particular the porosity. The heating element doped portion may be between 5 micrometres and 100 micrometres in thickness. The thickness of the heating element doped portion may be increased where the cross sectional area of the heating element is smaller or where the heating resistance required is higher. The heating element dopant used to dope the porous body may be an n-type dopant or a p-type dopant. The heating element dopant may be any one of, but not limited to, nitrogen, phosphorous, aluminium or boron. The interface between the thermally insulating layer and the porous body may comprise a portion of partially doped porous material.

According to an example of the present disclosure, there is provided a heater assembly for an aerosol-generating system. The heater assembly may comprise a heating element for vaporising a liquid aerosol-forming substrate. The heater assembly may comprise a porous ceramic body for conveying the liquid aerosol-forming substrate to the heating element. The porous ceramic body may have a liquid absorption surface and a heating surface. The heating element may be located on and bonded to the heating surface of the porous ceramic body. A thermally insulating layer may be disposed between the heating element and the porous ceramic body.

According to an example of the present disclosure, there is provided a heater assembly for an aerosol-generating system. The heater assembly comprises a heating element for vaporising a liquid aerosol-forming substrate. The heater assembly comprises a porous ceramic body for conveying the liquid aerosol-forming substrate to the heating element. The porous ceramic body has a liquid absorption surface and a heating surface. The heating element is located on and bonded to the heating surface of the porous ceramic body. A thermally insulating layer is disposed between the heating element and the porous ceramic body.

The bonding of the heating element to the heating surface of the porous ceramic body may advantageously provide a heater assembly which is easier to reliably manufacture and assemble, thus resulting in a more energy efficient heater assembly capable of generating a more consistent aerosol. This, in turn, may provide a user of the aerosol-generating system with an improved and more enjoyable experience. Such an arrangement may also help to reduce the likelihood of a user experiencing dry heating or a dry puff.

An advantage of providing the heating element on and bonded to a heating surface of the porous ceramic body is that it helps to alleviate the problems of manufacturing tolerances encountered with wick and coil heaters and other arrangements in which a heating element is detached from a liquid transport element. The dimensions and arrangement of the electrical heating element relative to the porous body are also fixed, which helps to produce a more consistent aerosol. This is because the electrical heating element is fixed to the porous ceramic body, which helps to supply liquid aerosol-forming substrate to the heating element. This also helps to prevent unwanted loss of heat, which helps to improve energy efficiency.

By providing the heating element on and bonded to a heating surface of the porous ceramic body with the thermally insulating layer therebetween, the resulting aerosol-generating system may benefit from reduced material requirements. This is because the need for intermediate fixing components which fix the heating element relative to the porous body can be reduced or eliminated entirely. The material savings can result in cost savings of the overall aerosol-generating system. An additional advantage of the reduced material requirements in the overall aerosol-generating system is the provision of a more sustainable and environmentally friendly solution.

According to an example of the present disclosure, there is provided an aerosol-generating system. The aerosol-generating system may comprise a heater assembly as discussed above. The heating element may be fluid permeable such that, in use, vapour is emitted from the heater assembly in an average vapour emission direction. The aerosol-generating system may further comprise an air inlet and an aerosol outlet. The air inlet may be in fluid communication with the aerosol outlet to define an airflow pathway through the aerosol-generating system. The heater assembly may be arranged in fluid communication with the airflow pathway such that air flows past the heater assembly in an average airflow direction. The heater assembly and airflow pathway may be arranged such that an angle between the average vapour emission direction and the average airflow direction is less than 135 degrees.

Advantageously, by arranging the heater assembly and airflow pathway such that the angle between the average vapour emission direction and the average airflow direction is less than 135 degrees, the average airflow direction does not directly oppose the average vapour emission direction. Therefore, the momentum of the vapour and the airflow is not reduced to the same extent as when the average airflow direction does directly oppose the average vapour emission direction. This reduces the tendency for recirculation and turbulence to occur in the airflow path and the vapour is less likely to impinge on the internal surfaces of the aerosol-generating system. Accordingly, condensation of aerosol within the aerosol-generating system is less likely to occur.

The average vapour emission direction may be substantially perpendicular to a heating surface of the thermally insulating layer. The average vapour emission direction may be substantially perpendicular to a heating surface of the porous body. As used herein, the term “substantially perpendicular” means 90 degrees plus or minus 10 degrees, preferably plus or minus 5 degrees.

An advantage of the average vapour emission direction being substantially perpendicular to the heating surface of the thermally insulating layer is that it makes orientating the average vapour emission direction relative to the average airflow direction straightforward because the vapour will be emitted substantially perpendicular to the heating surface of the of the thermally insulating layer. Therefore, by angling the heater assembly appropriately relative to the airflow in the airflow pathway or vice versa, a desired angle between the average vapour emission direction and average airflow direction can be achieved.

The heater assembly and airflow pathway may be arranged such that an angle between the average vapour emission direction and the average airflow direction is less than 110 degrees, preferably less than 100 degrees.

The heater assembly and airflow pathway may be arranged such that an angle between the average vapour emission direction and the average airflow direction is approximately 90 degrees. This arrangement results in the vapour being emitted at an angle substantially perpendicular to the average airflow direction. The average vapour emission direction has no speed or direction component that opposes the airflow direction and therefore any loss of momentum of the airflow is reduced. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

The heater assembly and airflow pathway may be arranged such that an angle between the average vapour emission direction and the average airflow direction is less than 90 degrees. In this arrangement, the average vapour emission direction has no speed or direction component that opposes the airflow direction and actually has a speed and direction component in the same direction as the average airflow direction. Therefore, any loss of momentum of the airflow is further reduced. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

The heater assembly and airflow pathway may be arranged such that an angle between the average vapour emission direction and the average airflow direction is approximately 45 degrees. The heater assembly and airflow pathway may be arranged such that an angle between the average vapour emission direction and the average airflow direction is less than 45 degrees.

The heater assembly and airflow pathway may be arranged such that the average vapour emission direction and the average airflow direction are substantially the same. In this arrangement, there is virtually no loss of momentum of the airflow as the average vapour emission direction and average airflow direction are the same. This reduces the tendency for recirculation and turbulence to occur in the airflow path and the vapour is less likely to impinge on the internal surfaces of the aerosol-generating system. Furthermore, entrainment of the vapour in the airflow is improved. Accordingly, condensation of aerosol within the aerosol-generating system is less likely to occur.

A cross-sectional area of the airflow pathway in the region of the heater assembly may be configured such that, in use, the airflow speed is between 0.1 and 2 metres per second, preferably between 0.5 and 1.5 metres per second and more preferably approximately 1 metre per second. This range of airflow speeds has been found to effectively entrain the vapour emitted from different designs of heating element without excessively cooling the heating element.

The heating element may comprise a porous layer of electrically conductive material. Advantageously, a heating element comprising a porous layer of electrically conductive material allows an electrical current to flow through the heating element such that the heating element can be resistively heated and also allows vapours to travel through the heating element via the pores in its porous structure. Thus vapour emission occurs through the porous heating element. This avoids the build-up of vapour pressure underneath the heating element and high speed vapour emission at the sides of the heating element. The inventors have found that this arrangement produces a consistent vapour across the heating element and a lower vapour emission speed of approximately 0.1 metres per second. Such a low vapour emission speed means that the vapour is easily carried away by the airflow reducing the impingement of vapour on the internal walls of the aerosol-generating system.

The porous body may have a liquid absorption surface and a heating surface. The thermally insulating layer may be disposed on the heating surface. The liquid absorption surface of the porous body may have an area that is different to an area of the heating surface of the porous body. The porous body may comprise a porous ceramic body or a porous glass body. The porous body may be substantially incompressible. The porous body may be incompressible.

A heater assembly having a heating surface with the same area as the liquid absorption surface may be inefficient due to heat generated by the heater not being used to vaporise an aerosol-forming substrate. An inefficient heater assembly provides a reduced throughput of aerosol.

Advantageously, providing a porous body in which the heating surface and the liquid absorption surface have different areas may improve the throughput of aerosol that can be generated by the heater assembly compared to a heater assembly in which the heating surface has the same area as the liquid absorption surface.

Increasing heating efficiency may reduce power consumption during use of the heater assembly.

The area of the heating surface of the porous body may be less than the area of the liquid absorption surface of the porous body. The area of the heating surface of the thermally insulating layer may be less than the area of the liquid absorption surface of the porous body. The area of the liquid absorption surface of the porous body may be greater than the area of the heating surface of the porous body. The area of the liquid absorption surface of the porous body may be greater than the area of the heating surface of the thermally insulating layer.

Advantageously, when the porous body has a shape such that the heating surface has a smaller area than the liquid absorption surface, heat flow from the heating element towards the liquid absorption surface and then to the liquid storage portion by conduction may be reduced. The relatively smaller heating surface provides a small heat transfer area through which heat can be transferred, by conduction, from the heating element to the porous body, and towards the liquid absorption surface.

Decreasing heat loss from the heating element to the bulk of the porous body may consequently increase heating efficiency because more of the heat energy provided by the heating element may be used to vaporise the aerosol-forming substrate. Consequently, the porous body having a shape such that the heating surface has a smaller area than the liquid absorption surface may increase the throughput of aerosol generated by the heater assembly.

Advantageously, the porous body having a shape such that the heating surface has a smaller area than the liquid absorption surface may reduce the area of the heating surface that is not close enough to the heating element to allow aerosol-forming substrate being conveyed to the heating surface to be vaporised. In other words, the size and shape of the heating surface may more closely match with the size and shape of the heating element. Consequently, more of the liquid aerosol-forming substrate may be conveyed from the liquid absorption surface to an area of the heating surface that is near to the heating element, which may result in more of the liquid aerosol-forming substrate at the heating surface being vaporised. More liquid aerosol-forming substrate being vaporised may increase the throughput of aerosol generated by the heater assembly. Further, this arrangement may allow for the power density at the heating surface to be maximised, which also improves heating efficiency.

Advantageously, the liquid absorption surface having a larger area than the heating surface may allow the liquid absorption surface to receive a larger volume of liquid aerosol-substrate from a liquid storage portion. As a consequence of the relatively smaller area of the heating surface, as the liquid aerosol-forming substrate is conveyed through the porous body and towards the heating surface, the flow rate of the liquid aerosol-forming substrate to the heating element may be higher than with a typical heater assembly. A higher flow rate of liquid aerosol-forming substrate at the heating element may increase the throughput of aerosol generated by the heater assembly.

The area of the heating surface of the porous body may be greater than the area of the liquid absorption surface of the porous body. The area of the liquid absorption surface of the porous body may be less than the area of the heating surface of the porous body.

Advantageously, when the porous body has a shape such that the liquid absorption surface has a smaller area than the heating surface, the smaller area of the liquid absorption surface may cause a reduction in heat flow through the aerosol-forming substrate from the heating element to the liquid absorption surface via heat conduction. Reducing heat flow from the heating surface to the liquid absorption surface may consequently increase thermal efficiency because more of the heat energy provided by the heating element may be used to vaporise the liquid aerosol-forming substrate. Consequently, the porous body having a shape such that the liquid absorption surface has a smaller area than the heating surface may provide for increased heating efficiency, which may increase the throughput of aerosol generated by the heater assembly.

Advantageously, the porous body having a shape such that the liquid absorption surface has a smaller area than the heating surface may reduce the area of the heating surface that is not close enough to the heating element to allow aerosol-forming substrate being conveyed to the heating surface to be vaporised. In other words, the size and shape of the heating surface may more closely match with the size and shape of the heating element. Consequently, more of the liquid aerosol-forming substrate being may be conveyed from the liquid absorption surface and to an area of the heating surface that is near to the heating element, which may result in more of the liquid aerosol-forming substrate at the heating surface being vaporised. More liquid aerosol-forming substrate being vaporised may increase the throughput of aerosol generated by the heater assembly.

The heating surface of the porous body may be convex in one or both of a first transverse direction and a second transverse direction, the first transverse direction being orthogonal to the second transverse direction. The thermally insulating layer may be disposed on the heating surface of the porous body. A heating surface of the thermally insulating layer may be convex in one or both of a first transverse direction and a second transverse direction, the first transverse direction being orthogonal to the second transverse direction.

Inclusion of such a porous body or thermally insulating layer may enable the surface area of the heating surface to be increased without increasing a volume of the porous body. This may increase the efficiency of the heater assembly at vaporising liquid aerosol-forming substrate, since it may enable the surface area of the heating assembly that is available for vaporising the liquid aerosol-forming substrate to be increased without increasing the volume of the porous body through which heat loss may occur via conduction.

The provision of a heating surface that is convex in one or both of a first transverse direction and a second transverse direction may enable the surface area of the heating surface to be increased without increasing a width of the heating surface. This may increase the efficiency of the heater assembly at vaporising liquid aerosol-forming substrate, whilst helping to avoid the need to redesign other components of the aerosol-generating system to accommodate the porous body.

The provision of a heating surface that is convex along one or both of a first transverse direction and a second transverse direction may help to avoid or minimise recirculation of airflow adjacent the heater assembly. In particular, a heating surface that is convex may help to avoid or minimise recirculation of airflow adjacent to a central region of the heater assembly. This may reduce a level of turbulence in the airflow adjacent to the heater assembly. Reducing a level of turbulence in the airflow adjacent to the heater assembly may improve the entrainment of vapour of aerosol-forming substrate in the airflow. This may improve the quality of the aerosol generated by the aerosol-generating system.

Improving the entrainment of vapour in the airflow through the aerosol-generating system may avoid or reduce vapour condensing to form large droplets of liquid aerosol-forming substrate. This may help to avoid an unpleasant and undesirable user experience.

Improving the entrainment of vapour in the airflow through the aerosol-generating system may avoid or reduce vapour condensing on internal surfaces of the aerosol-generating system. This may help to avoid or minimise damage to the aerosol-generating system and may allow optimal function of the aerosol-generating system.

The heating surface of the porous body or of the thermally insulating layer may be convex in a single transverse direction.

The heating surface of the porous body or of the thermally insulating layer may be convex in both the first transverse direction and the second transverse direction.

The heating surface of the porous body or of the thermally insulating layer may be convex in one or both of the first transverse direction and the second transverse direction based on the configuration of the heater assembly relative to one or more airflow pathways of the aerosol-generating system. The heater assembly may be configured to minimise a level of turbulence in the airflow adjacent to the heater assembly. For example, it may be advantageous for the heater assembly to be arranged in the aerosol-generating system such that air drawn into the aerosol-generating system follows a curved path along at least a portion of a curved surface of the heater assembly.

The heating element may be convex in one or both of the first transverse direction and the second transverse direction.

The curvature of the heating element or of the thermally insulating layer in the first transverse direction may be substantially the same as the curvature of the heating surface of the porous body or of the thermally insulating layer in the first transverse direction. The curvature of the heating element or of the thermally insulating layer in the second transverse direction may be substantially the same as the curvature of the heating surface of the porous body or of the thermally insulating layer in the second transverse direction. The curvature of the heating element or of the thermally insulating layer in both the first transverse direction and the second transverse direction may be substantially the same as the curvature of the heating surface of the porous body or of the thermally insulating layer in both the first transverse direction and the second transverse direction, respectively.

The average pore size of the porous body may vary between the liquid absorption surface and the heating surface of the porous body.

The provision of a porous body which includes a variation of pore size between the liquid absorption surface and the heating surface of the porous body may advantageously help to control the transport of liquid aerosol-forming substrate from a reservoir of liquid aerosol-forming substrate to the heating element. Specifically, the variation of pore size between the liquid absorption surface and the heating surface of the porous body may allow the porous body to provide a consistent supply of aerosol-forming substrate to the heating surface. This may advantageously avoid undesirable “dry heating”. In addition, the porous body of the present invention may also advantageously prevent leakage of liquid aerosol-forming substrate from the heating surface of the porous body.

The average pore size of the porous body may vary in any way between the liquid absorption surface and the heating surface of the porous body. The average pore size may vary from relatively larger pores at the liquid absorption surface to relatively smaller pores at the heating surface of the porous body.

The provision of a porous body having a larger average pore size at the liquid absorption end, and a smaller average pore size at a heating end of the porous body may particularly facilitate efficient transfer of liquid aerosol-forming substrate from the liquid absorption end of the porous body to the heating end of the porous body without allowing leakage. In particular, the inventors of the present invention have identified that liquid aerosol-forming substrate is transferred from the liquid absorption end of the porous body to the heating end of the porous body by capillary action. How rapidly the liquid aerosol-forming substrate moves through the porous body depends on a number of factors including, but not limited to, the geometry of the pores, the surface tension between the liquid aerosol-forming substrate and the porous body, the viscosity of the liquid aerosol-forming substrate, the surface tension of the liquid aerosol-forming substrate, and the overall geometry of the porous body. The inventors of the present invention have identified the need to balance these factors to provide efficient transfer of liquid aerosol-forming substrate to the heating surface of the porous body while preventing leakage of the liquid aerosol-forming substrate.

Firstly, in order to provide an efficient capillary flow of liquid through the porous body, the capillary pressure must overcome the viscous drag pressure. Secondly, to prevent leakage, inertial forces must not overcome the capillary pressure. These two requirements are realised by providing a porous body with larger pores at the liquid absorption end and smaller pores at the heating end of the porous body.

In particular, the inventors of the present invention have realised that the viscosity of the liquid aerosol-forming substrate varies with temperature. In particular, the viscosity of the liquid aerosol-forming substrate decreases as its temperature increases. As a result, as the liquid aerosol-forming substrate moves through the porous body from the liquid absorption surface to the heating surface of the porous body, the viscosity of the liquid aerosol-forming substrate decreases. Since the liquid aerosol-forming substrate is transported through the porous body by capillary forces, the capillary force needs to overcome the viscous drag of the liquid. The viscous drag decreases as viscosity decreases. As a result, the capillary force needed to move the liquid aerosol-forming substrate can decrease towards the heating surface of the porous body while still maintaining the same flow rate. Consequently, the average pore size of the porous body can decrease towards the heating surface of the porous body without reducing the flow of liquid aerosol-forming substrate through the porous body.

Features described in relation to one of the above examples may equally be applied to other examples of the present disclosure.

The invention is defined in the claims. However, below there is provided a non-exhaustive list of non-limiting examples. Any one or more of the features of these examples may be combined with any one or more features of another example, embodiment, or aspect described herein.

Example Ex1. A heater assembly for an aerosol-generating device, the heater assembly comprising:
a heating element for vaporising a liquid aerosol-forming substrate;
a porous body for conveying the liquid aerosol-forming substrate to the heating element; and
a thermally insulating layer having a lower thermal conductivity than the porous body, wherein the thermally insulating layer is disposed between and is in contact with each of the porous body and the heating element, and the thermally insulating layer is configured to reduce heat transfer from the heating element to the porous body, wherein the porous body comprises a porous ceramic body or a porous glass body.

Example Ex2. The heater assembly according to Ex1, wherein the thermally insulating layer comprises a thermally insulating material, the thermally insulating material having a lower thermal conductivity than the porous body.

Example Ex3. The heater assembly according to Ex1 or Ex2, wherein the thermally insulating layer comprises a material having a thermal conductivity of less than 40 Watts per metre-Kelvin.

Example Ex4. The heater assembly according to any of the preceding Examples, wherein the thermally insulating layer comprises a material having a thermal conductivity of less than 10 Watts per metre-Kelvin.

Example Ex5. The heater assembly according to any of the preceding Examples, wherein the thermally insulating layer comprises a thermally insulating material, the thermally insulating material having a higher porosity than the porous body.

Example Ex6. The heater assembly according to any of the preceding Examples, wherein the thermally insulating layer extends entirely between the porous body and the heating element.

Example Ex7. The heater assembly according to any of the preceding Examples, wherein the thermally insulating layer comprises one or more of: alumina, zirconia, zirconia with magnesium oxide, glass ceramic, quartz, a porous polymer.

Example Ex8. The heater assembly according to any of the preceding Examples, wherein the thermally insulating layer has a thickness of between 0.1 mm and 2 mm, preferably between 0.5 mm and 1.5 mm.

Example Ex9. The heater assembly according to any of the preceding Examples, wherein the heating element is a porous heating element.

Example Ex10. The heater assembly according to any of the preceding Examples, wherein the thermally insulating layer has a heating surface, and the heating element extends to cover an area of the heating surface of the thermally insulating layer.

Example Ex11. The heater assembly according to any of the preceding Examples, wherein the heating element comprises a plurality of tracks or track portions arranged with a distance between at least two of the plurality of tracks or track portions in the range 150 to 300 micrometres.

Example Ex12. The heater assembly according to any of the preceding Examples, wherein the porous body comprises an electrically insulating material.

Example Ex13. The heater assembly according to any of the preceding Examples, wherein the heating element and the porous body are integrally formed.

Example Ex14. The heater assembly according to any of the preceding Examples, wherein the thermally insulating layer has a heating surface, and the heating element is located on and bonded to the heating surface of the thermally insulating layer.

Example Ex15. The heater assembly according to any of the preceding Examples, wherein the porous body has a liquid absorption surface and a heating surface,
the heating element and the thermally insulating layer being located on the heating surface of the porous body,
wherein the liquid absorption surface of the porous body has an area that is different to an area of the heating surface of the porous body.

Example Ex16. The heater assembly according to Ex15, wherein the area of the heating surface of the porous body is less than the area of the liquid absorption surface of the porous body.

Example Ex17. The heater assembly according to Ex14 or Ex15, wherein the area of the liquid absorption surface of the porous body is less than the area of the heating surface of the porous body.

Example Ex18. The heater assembly according to any of the preceding Examples, wherein the porous ceramic body has a liquid absorption surface and a heating surface,
wherein the heating element and the thermally insulating layer are located on the heating surface of the porous ceramic body, and
wherein the heating surface of the porous body is convex in one or both of a first transverse direction and a second transverse direction, the first transverse direction being orthogonal to the second transverse direction.

Example Ex19. The heater assembly according to Ex18, wherein the heating surface of the porous body has a radius of curvature of at least about 1.5 millimetres.

Example Ex20. The heater assembly according to any of the preceding Examples, wherein the porous body has a liquid absorption surface and a heating surface,
the heating element being located on the heating surface of the porous body,
wherein the average pore size of the porous body varies between the liquid absorption surface and the heating surface.

Example Ex21. The heater assembly according to Example Ex20, wherein the heating element, the thermally insulating layer and the porous body are integrally formed.

Example Ex22. The heater assembly according to Example Ex20 or Example Ex21, wherein the porous body has a heating end and a liquid absorption end, the heating surface being disposed at the heating end, and the liquid absorption surface being disposed at the liquid absorption end,
wherein the porous body has a first average pore size at the liquid absorption end, and a second average pore size at the heating end, first average pore size being greater than the second average pore size.

Example Ex23. The heater assembly according to any of the preceding Examples, wherein the heating element comprises a plurality of tracks or track portions arranged electrically in parallel.

Example Ex24. The heater assembly according to any of the preceding Examples, wherein the heating element comprises a plurality of tracks or track portions defining a path having at least one bend, the inner edge of the bend being curved.

Example Ex25. An aerosol-generating system comprising the heater assembly of any of the preceding Examples, wherein the heating element is fluid permeable such that, in use, vapour is emitted from the heater assembly in an average vapour emission direction;
wherein the aerosol-generating system further comprises an air inlet and an aerosol outlet, the air inlet being in fluid communication with the aerosol outlet to define an airflow pathway through the aerosol-generating system;
wherein the heater assembly is arranged in fluid communication with the airflow pathway such that air flows past the heater assembly in an average airflow direction, wherein the heater assembly and airflow pathway are arranged such that an angle between the average vapour emission direction and the average airflow direction is less than 135 degrees.

Examples will now be further described with reference to the accompanying Figures, wherein:

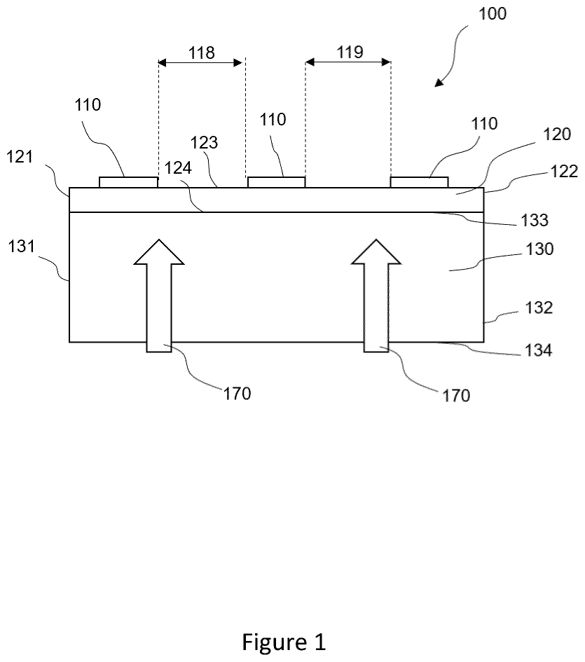

FIG. 1 is a schematic illustration of a cross-section through a heater assembly in accordance with an example of the present disclosure, in which the heating element is a track heater;

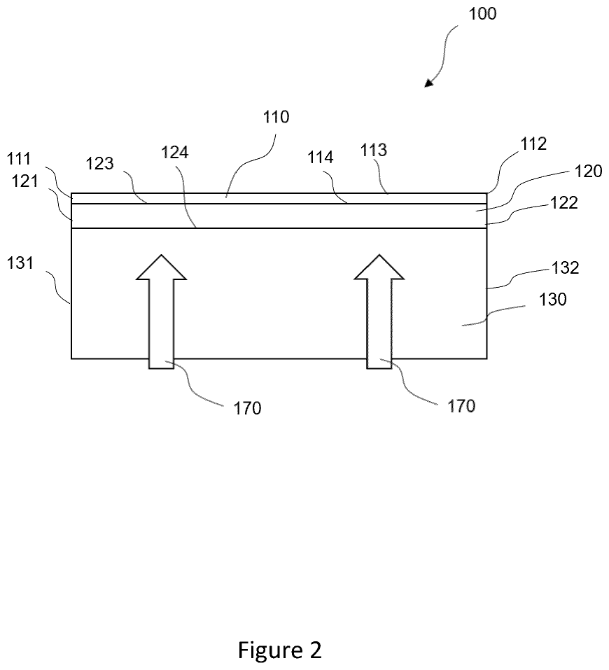

FIG. 2 is a schematic illustration of a cross-section through a heater assembly in accordance with an example of the present disclosure, in which the heating element is a porous layer;

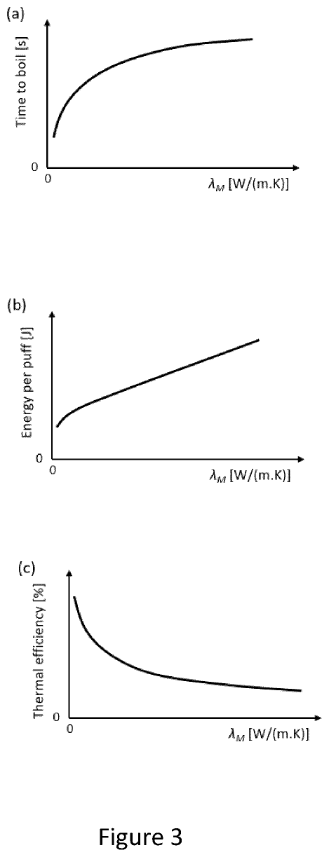

FIGS. 3 (a) to 3 (c) are graphs showing the influence of increasing thermal conductivity on various factors;

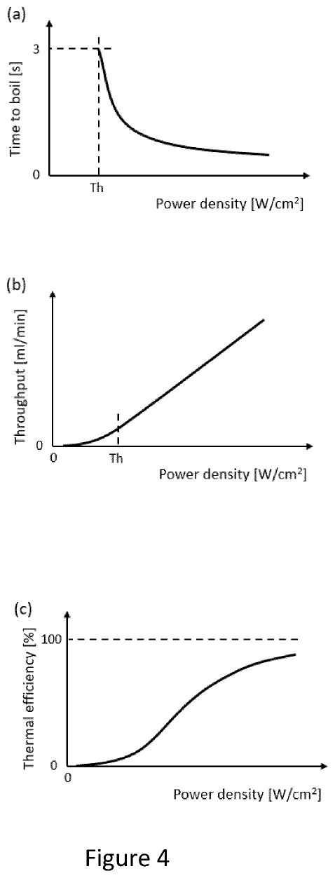

FIGS. 4 (a) to 4 (c) are graphs showing the influence of increasing power density on (a) time to boil, (b) throughput, and (c) thermal efficiency;

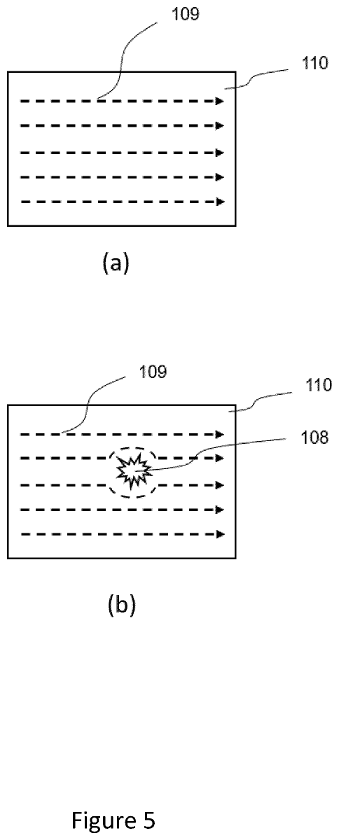

FIGS. 5 (a) and 5 (b) are schematic illustrations depicting current flow through a porous heating element (a) without defects, and (b) with a defect;

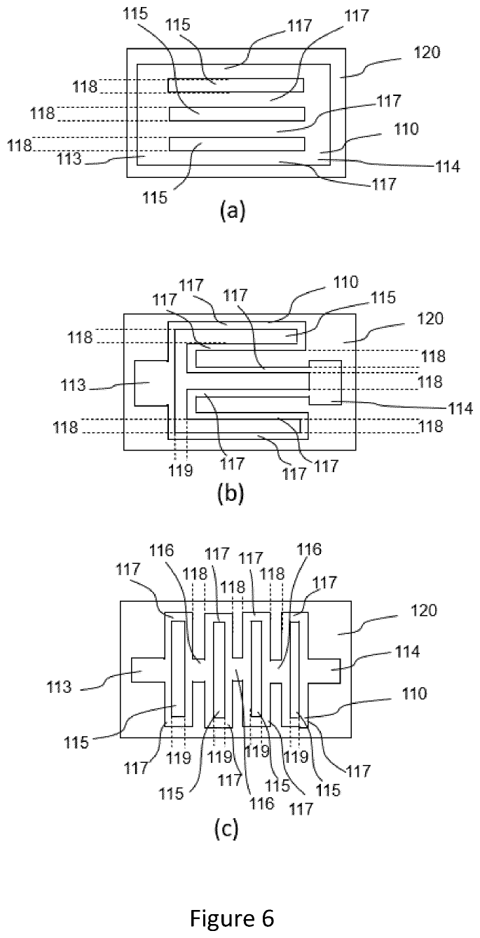

FIGS. 6 (a) to 6 (c) are schematic illustrations depicting heating element tracks; and

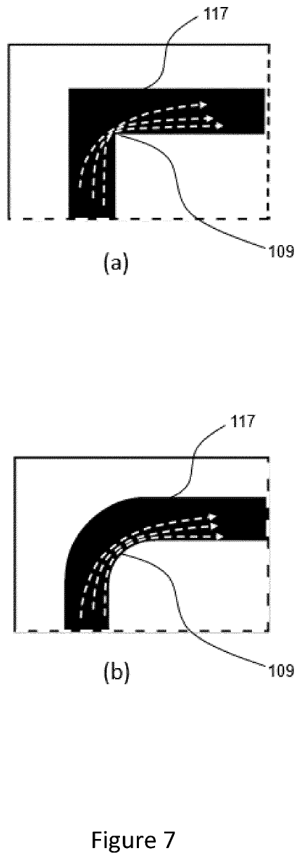

FIGS. 7 (a) and 7 (b) are schematic illustrations depicting current flow around a corner of a heating element track;

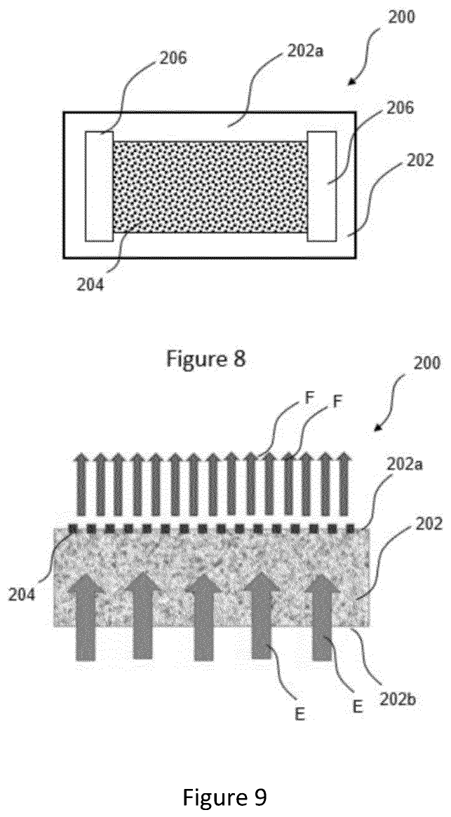

FIG. 8 is a schematic plan view of a heater assembly according to an example of the present disclosure;

FIG. 9 is a schematic cross-sectional view of the heater assembly of FIG. 8;

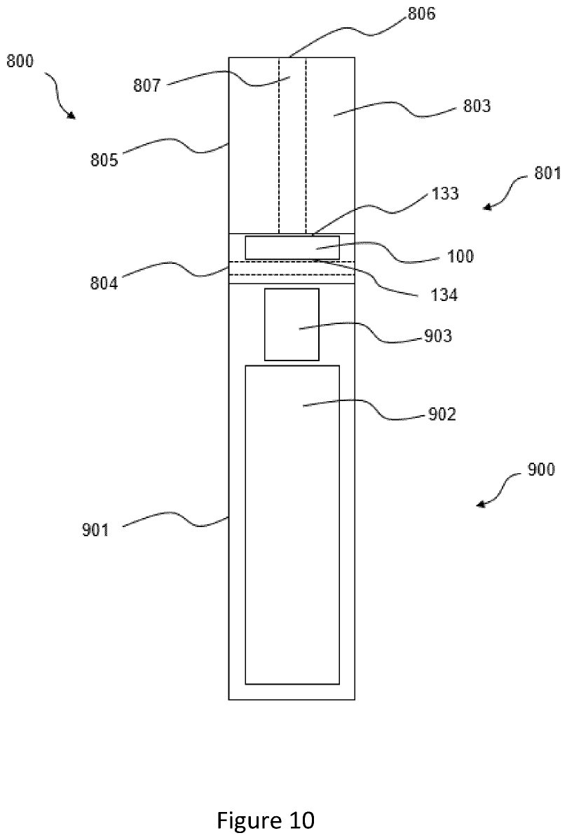

FIG. 10 is a schematic view of the interior of an aerosol-generating system according to an example of the present disclosure;

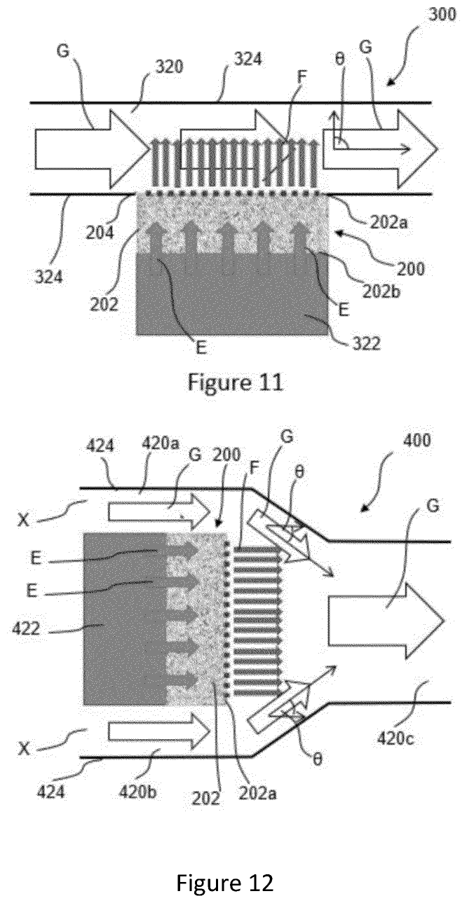

FIG. 11 is a schematic cross-sectional view of part of an aerosol-generating system according to another example of the present disclosure showing an arrangement of a heater assembly relative to an airflow pathway within the aerosol-generating system;

FIG. 12 is a schematic cross-sectional view of part of another aerosol-generating system according to another example of the present disclosure showing another arrangement of a heater assembly relative to an airflow pathway within the aerosol-generating system;

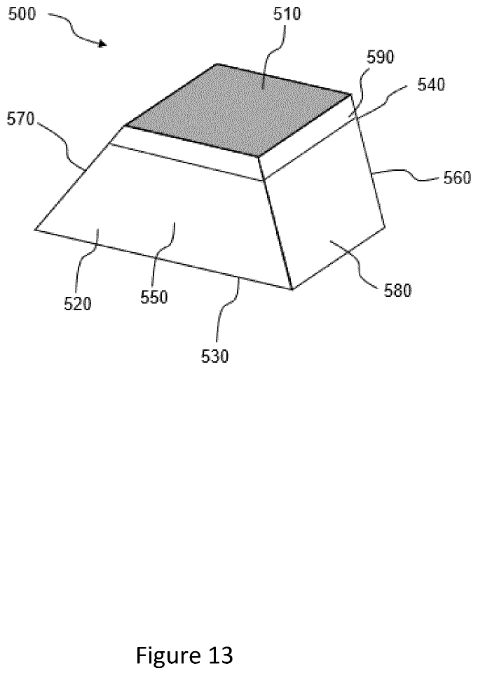

FIG. 13 is a schematic view of a heater assembly according to an example of the present disclosure;

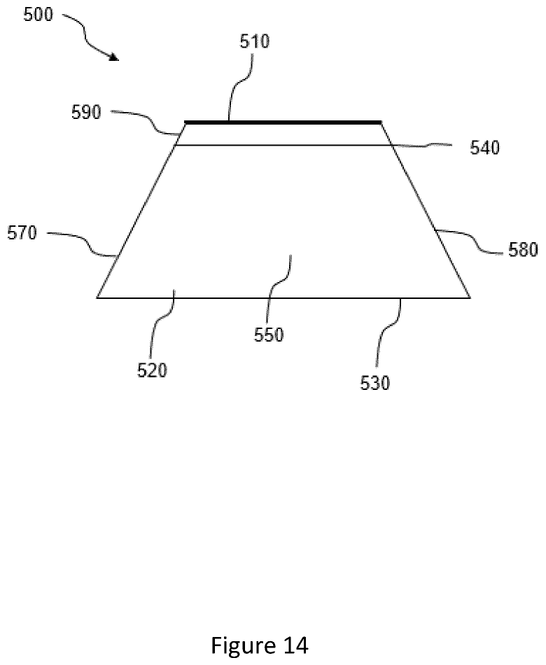

FIG. 14 is a side view of the schematic of FIG. 13;

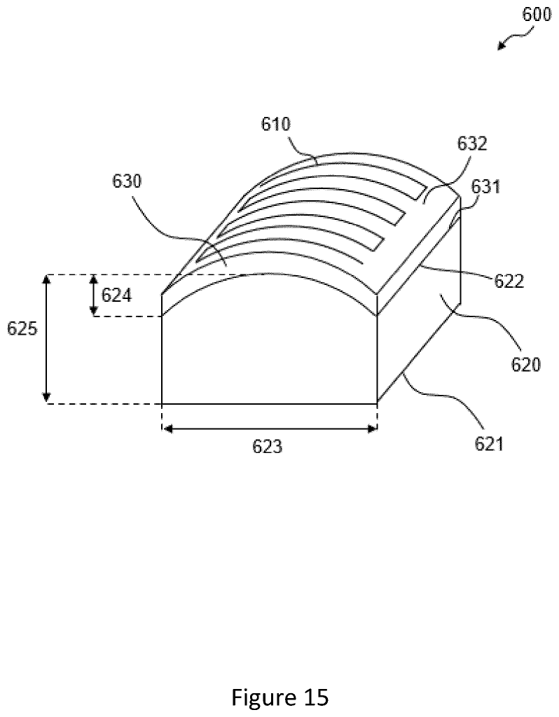

FIG. 15 is a schematic view of a heater assembly according to an example of the present disclosure.

The above and other features and advantages of example embodiments will become more apparent by describing in detail, example embodiments with reference to the attached drawings. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

Spatially relative terms (for example, “below”) may be used herein for ease of description to describe one element or feature's relationship to another element or feature as illustrated in the figures. It should be understood that the spatially relative terms are intended to encompass different orientations of the device in use or operation in addition to the orientation depicted in the figures. For example, if the device in the figures is turned over, elements described as “below” other elements or features would then be oriented “above” the other elements or features. Therefore, the term “below” may encompass both an orientation of above and below. The device may be otherwise oriented (rotated 90 degrees or at other orientations) and the spatially relative descriptors used herein interpreted accordingly.

It should be understood that when an element or layer is referred to as being “disposed on”, another element or layer, it may be directly on, connected to, coupled to, or covering the other element or layer, or intervening elements or layers may be present. In contrast, when an element is referred to as being “directly disposed on” another element or layer, there are no intervening elements or layers present.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and “comprising,” when used in this specification, specify the presence of stated features, integers, steps, operations or elements, but do not preclude the presence or addition of one or more other features, integers, steps, operations, elements or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques or tolerances, are to be expected. Therefore, example embodiments should not be construed as limited to the shapes of regions illustrated herein but are to include deviations in shapes that result, for example, from manufacturing. Therefore, the regions illustrated in the figures are schematic in nature and their shapes are not intended to illustrate the actual shape of a region of a device and are not intended to limit the scope of example embodiments. The same reference numerals represent the same elements throughout the drawings. The accompanying drawings are not to be considered as drawn to scale unless explicitly noted. It will be appreciated that the figures in the application are schematic, and that some features have been omitted for the sake of clarity.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

The accompanying drawings are intended to depict example embodiments and should not be interpreted to limit the intended scope of the claims.

Referring to FIG. 1, there is shown a schematic illustration of a heater assembly 100 for an aerosol-generating system, in accordance with an example of the present disclosure. The heater assembly 100 comprises: a heating element 110, a thermally insulating layer 120, a porous body 130, and electrical control circuitry (not shown for clarity).

The porous body 130 is configured to supply liquid aerosol-forming substrate to the heating element 110. Specifically, the porous body 130 is configured to transmit liquid aerosol-forming substrate from a liquid reservoir (not shown in FIG. 1 for clarity) to the heating element 110. The porous body 130 is configured to store some liquid aerosol-forming substrate before aerosolization by the heating element 110.

The porous body 130 is a rectangular block. The porous body 130 has a first end face and an opposing second end face. The first end face is a liquid absorption surface 134 and the second end face is a heating surface 133. In this example, the liquid absorption surface 134 and the heating surface 133 are both substantially flat surfaces. The porous body 130 also has a plurality of lateral faces extending between the liquid absorption surface 134 and the heating surface 133. The porous body 130 has a first lateral face 131 opposing a second lateral face 132, and a third lateral face (not shown) opposing a fourth lateral face (not shown). The porous body 130 has a thickness defined between the liquid absorption surface 134 and the heating surface 133.

The porous body 130 comprises a plurality open-cell pores. The plurality of open-cell pores are interconnected to provide a fluid pathway for aerosol-generating liquid through the porous body 130. The heater assembly 100 may be configured such that liquid can pass through the fluid pathway of the porous body 130 to the heating element 110, as depicted by arrows 170. The porous body 130 is configured for fluid 170 to pass from the liquid absorption side 134 to the heating surface 133. The porous body 130 comprises a material which does not chemically interact with the liquid aerosol-forming substrate. The porous body 130 comprises ceramic. The porous body 130 comprises porous ceramic, such as but not limited to one or more of: Al₂O₃, ZrO₂, Si₃N₄, SiC, Ti₃AlC₂, BN, AlN, SiO₂, MgO, mica, diatomite, silicates, silicides, borides, glass. It will be appreciated that the porous body 130 may have a different shape or comprise a different material.

The heating element 110 is configured to heat a liquid aerosol-forming substrate to form an aerosol. The heating element 110 is configured to convert electrical energy into heat energy by material resistance of the heating element 110 to an electrical current.

The heating element 110 comprises a track defining a path across a heating surface 123 of the thermally insulating layer 120. The heating element 110 defines a serpentine or an electrically parallel track shape across the heating surface 123 of the thermally insulating layer 120. Three cross-sections through portions of the track of the heating element 110 are shown in FIG. 1. The plurality of track portions are arranged with distances between at least two of the plurality of track portions 118, 119 in the range 150 to 300 micrometres. The track portions are evenly spaced. It will be appreciated that distances between at least two of the plurality of track portions 118, 119 may not be equal.

The heating element 110 is elongate. The heating element 110 comprises metal, such as but not limited to stainless steel, Ni—Cr alloy, NiCrAlY alloy, FeCrAl alloys (e.g., Kanthal), FeCrAlY alloys, Fe₃Al alloy, Ni₃Al alloy, NiAl alloy, and CuNi alloys. It will be appreciated that the heating element 110 may have a different shape or comprise a different material.

The heating element 110 is arranged along an outer surface of the thermally insulating layer 120. The heating element 110 is in direct contact with the thermally insulating layer 120.

The thermally insulating layer 120 is arranged to enhance thermal insulation between the heating element 110 and the porous body 130. The thermally insulating layer 120 is arranged to extend across at least a portion of the heating element 110 to thermally insulate the heating element 110 from the porous body 130. The thermally insulating layer 120 is configured to reduce heat dissipation through the porous body 130, so as to enhance energy efficiency by reducing energy losses.

The thermally insulating layer 120 is planar. The thermally insulating layer 120 has a size and a shape configured to extend across the electrical heating element 110. The thermally insulating layer 120 is configured to entirely extend across a surface of the heating element 110. The thermally insulating layer 120 is configured to substantially cover the porous body 130 below the thermally insulating layer 120.

The thermally insulating layer 120 has a first end face and an opposing second end face. The first end face is a liquid absorption surface 124 and the second end face is a heating surface 123. In this example, the liquid absorption surface 124 and the heating surface 123 are both substantially flat surfaces. The liquid absorption surface 124 of the thermally insulating layer 120 is in direct contact with the porous body 130. The heating surface 123 of the thermally insulating layer 120 is in direct contact with the heating element 110,

The thermally insulating layer 120 also has a plurality of lateral faces extending between the liquid absorption surface 124 and the heating surface 123. The thermally insulating layer 120 has a first lateral face 121 opposing a second lateral face 122, and a third lateral face (not shown) opposing a fourth lateral face (not shown).

The thermally insulating layer 120 is configured such that first lateral face 121 of the thermally insulating layer 120 extends up to the first lateral face 131 of the porous body 130. The thermally insulating layer is configured such that second lateral face 122 of the thermally insulating layer 120 extends up to the second lateral face 132 of the porous body 130. The thermally insulating layer is configured such that third lateral face of the thermally insulating layer 120 extends up to the third lateral face of the porous body 130. The thermally insulating layer is configured such that fourth lateral face of the thermally insulating layer 120 extends up to the fourth lateral face of the porous body 130.

The thermally insulating layer 120 has a thickness defined between the liquid absorption surface 124 and the heating surface 123. The thickness of the thermally insulating layer 120 is less than the thickness of the porous body 130. The thermally insulating layer may have a thickness between 0.1 mm and 2 mm, preferably between 0.5 mm and 1.5 mm.

The thermally insulating layer 120 comprises a material having a low thermal conductivity. The thermally insulating layer 120 comprises or consists of a material with a lower thermal conductivity than the porous body 130. The thermally insulating layer 120 may have a higher porosity than the porous body 130. The thermally insulating layer 120 may comprise a material such as one or more of: alumina, zirconia, zirconia with magnesium oxide, glass ceramic, quartz, a porous polymer. It will be appreciated that the thermally insulating layer 120 may have a different shape or comprise a different material.

Referring to FIG. 2, there is shown a schematic illustration of a heater assembly 100 for an aerosol-generating system, in accordance with a second example of the present disclosure. The heater assembly 100 comprises: a heating element 110, a thermally insulating layer 120, a porous body 130, and electrical control circuitry (not shown for clarity).

The porous body 130, and the thermally insulating layer 120 are as described in relation to the example shown in FIG. 1.

The heating element 110 of the second example is a porous heating element. The heating element 110 extends to cover an area of the heating surface of the thermally insulating layer 120.

The heating element 110 has a first end face and an opposing second end face. The first end face is a liquid absorption surface 114 and the second end face is an outer surface 113. In this example, the liquid absorption surface 114 and the outer surface 113 are both substantially flat surfaces. The liquid absorption surface 114 of the heating element 110 is in direct contact with the thermally insulating layer 120.

The heating element 110 also has a plurality of lateral faces extending between the liquid absorption surface 114 and the outer surface 113. The heating element 110 has a first lateral face 111 opposing a second lateral face 112, and a third lateral face (not shown) opposing a fourth lateral face (not shown).

The heating element 110 is configured such that first lateral face 111 of the heating element 110 extends up to the first lateral face 121 of the thermally insulating layer 120. The heating element 110 is configured such that second lateral face 112 of the heating element 110 extends up to the second lateral face 112 of the thermally insulating layer 120. The heating element 110 is configured such that third lateral face of the heating element 110 extends up to the third lateral face of the thermally insulating layer 120. The heating element 110 is configured such that fourth lateral face of the heating element 110 extends up to the fourth lateral face of the thermally insulating layer 120.

In the first and second examples, heat losses from the heating element to the porous body, and to liquid within the porous body, are reduced. In comparison to a known device lacking a thermally insulating layer, the heater assembly of the first and second examples is more efficient, as the amount of use and number of uses of the device by a user can be increased before the device battery is depleted.

To further demonstrate a problem addressed by the thermally insulating layer, the simulation below demonstrates heat loss and dissipation in a known heater assembly which does not have a thermally insulating layer. Such a known heater assembly has a porous body and an electrical heating element.

As a first approximation, heat is considered to dissipate in the porous body away from the heater through diffusion only (i.e. heat diffusion without considering advection induced by liquid movement towards the heated surface). In such a case, heat would spread to a distance d according to equation (1).

$$d = \sqrt{4 {α}_{M} {t}_{P}} \qquad ( 1 )$$

where α_{M} denotes the thermal diffusivity of the porous body and liquid it contains and t_{P} is the duration of a puff.

In a case where the α_{M} is 9.2e-8 m²/s and t_{P} 3 seconds, d=1.1 mm.

In a second approximation which may more closely model heat dissipation in practice, liquid is considered as flowing towards the heated surface, limiting the spread of heat away from the heated area. In this case, heat conduction in the porous body is the result of a competition between heat diffusion (in which heat is transferred from the heated surface into the bulk material of the porous body) and advection (in which liquid flow carries heat back to the heated surface).

In such an approximation, the temperature profile, T(z), as a function of the distance, z, from the heated surface asymptotes towards a steady state profile defined as:

$$T ( z ) = {T}_{R} + ( {T}_{H} - {T}_{R} ) exp ( \frac{{ε}_{W} {u}_{L}}{{α}_{M}} Z ) \qquad ( 2 )$$

in which z=0 at the heated surface, and z<0 when at a distance from the heated surface in the porous body, TR is the temperature of the liquid in the reservoir, and T_{H} is the temperature of the of the heated surface of the heating element, ε_{W} is the porosity of the porous body and u_{L} is the velocity of liquid in the porous body towards the heated area.

When the temperature of the heating element is 250 degrees Celsius, thermal diffusivity of the porous body is 9.2e-8 m²/s and liquid flows at a speed of 0.2 ml/min through a porous body of 25 mm² vaporization area with 50 percent of porosity, heat spreads backwards (i.e. away from the heating element into the porous body) by α_{M}/(ε_{W}u_{L})=0.5 mm.

In this approximation, to reduce heat loss in the porous body, the spread of heat away from the heated surface has to be minimized. This requires one or more of:
A high liquid flow speed (u_{L}) in the porous body,
A high porosity (ε_{W}) in the porous body,
A low thermal diffusivity (α_{M}).
   The thermal diffusivity, α_{M}, is the ratio of the thermal conductivity, k, to volumetric heat capacity, as represented by equation (3).

$${α}_{M} = k / ( ρ {c}_{p} ) \qquad ( 3 )$$

in which ρ, is material density and cₚ is the material specific heat capacity.
   Thermal diffusivity is reduced by selecting a porous body of high specific heat capacity and low thermal conductivity. Porous body materials such as but not limited to cotton, alumina and zirconia have low thermal conductivities coupled with reasonable specific heat capacities leading to low thermal diffusivities in the range of 10⁻⁸ to 3×10⁻⁵ m²/s.

The inventors have identified that thermal conductivity is influenced by a combination of the porous body with the liquid contained in the porous body. Increasing the thermal conductivity of the mixture of the porous body and liquid, λ_{M}, can be detrimental for the proper operation of the vaporization system.

Simulation results are illustrated in FIG. 3. FIG. 3 includes graphs showing the modelled effect of (a) increasing the thermal conductivity (λ_{M}) of the porous body and liquid mixture on the time to reach boiling, (b) increasing the thermal conductivity (λ_{M}) of the porous body and liquid combination on the required energy per puff and (c) increasing the thermal conductivity (λ_{M}) of the porous body and liquid combination on thermal efficiency. In the models on which the graphs in FIG. 3 were generated, the supplied power was adjusted to ensure a constant liquid throughput through the porous body of 0.2 ml/min. When increasing the thermal conductivity of the porous body and liquid combination, more energy diffuses through it. As shown in FIG. 3 (a), when increasing the thermal conductivity of the porous body and liquid combination, the time taken to reach a boiling point of the liquid increases. As shown in FIG. 3 (b), when increasing the thermal conductivity of the porous body and liquid combination, the required energy per puff increases. As shown in FIG. 3 (c), increasing the thermal conductivity of the porous body and liquid combination has a direct impact on energy efficiency (i.e. the ratio of the energy use for the actual vaporization of the liquid to the energy wasted in the mixture).

While an energy efficiency of 67 percent was found for a mixture with a thermal conductivity of 0.225 Watts per meter-Kelvin, energy efficiency decreased below 50 percent for thermal conductivities higher than 1 Watts per meter-Kelvin. The inventors thus identified that the porous body and the liquid can be designed to ensure a thermal conductivity as low as possible in order to enhance energy efficiency.

The inventors have also identified that power density of the heating element has an influence on the performance of the heating element. Simulation trends are provided in FIG. 4, for a heated surface on a combination of a porous body and liquid, the porous body and the liquid having a fixed thermal conductivity. As shown in FIG. 4 (a), the time taken to reach boiling decreases as power density of the heating element increases. A minimum power density is required to reach boiling during a puff, defining a threshold, Th. The simulations performed define a minimum power density that is required to ensure boiling of the liquid after 3 seconds, which is the duration of a puff according to the Coresta regime. This threshold depends on, among other factors, the surface of the heated area, and thermal properties of the porous body and liquid. As shown in FIG. 4 (b), a very low throughput is obtained at the threshold Th. Above the threshold Th, throughput increases approximately linearly with the supplied power density.

To ensure a usable throughput of 0.2 millilitres/minute (corresponding to 3.3 μl/s or 10 μl/puff of 3 seconds), a minimum power density of 25 Watts/cm² was simulated. Each 10 Watts/cm² of power in this simulation delivers 7.5 Joules per puff and, once the throughput is established, a fixed energy of approximately 6 Joules is wasted in heating the porous body, while the remainder of the supplied energy is delivered to vaporize the liquid. As a consequence, the thermal efficiency increases with the power density, as shown in FIG. 4 (c). Therefore, to maximize thermal efficiency, the vaporization surface area should remain as small as possible with a heater delivering a high power. This increases liquid flow speed in the porous body which reduces thermal losses in the porous body according to equation (2) (as higher u_{L} causes T(z) to decrease more quickly). This is, however, limited by liquid properties (surface tension, viscosity) and the throughput the porous body can accommodate (porosity). If insufficient liquid is supplied to the heating element, the heating element can overheat and eventually break.

In a model in which 0.5 mm of a heating side of the porous body is used as a heater (i.e., bulk heating) with a supplied power of 6.25 Watts, a boiling temperature of 250 degrees Celsius is reached after approximately 1.5 seconds, namely 0.5 seconds to 1.0 second later than surface heating (equation 1). This delay is due to the higher energy required (and wasted) to heat the porous body in bulk. While the energy delivered during a puff is 19 Joules (6.25 Watts×3 seconds), simulations indicated that 14 Joules is required to heat a 1 mm-thick slice of a 5×5 mm² porous body to 250 degrees Celsius. This energy is wasted and reduces the thermal efficiency of the vaporization system. Therefore, by ensuring that only the surface of the porous body is heated, for example by using a thermally insulating layer, heat diffusion to the porous body is minimized, and energy losses are reduced.

Referring to FIGS. 5 (a) and 5 (b), there are shown schematic illustrations of current flow 109 through a porous heating element 110, (a) without a defect, and (b) with a defect 108. In this case, the heating element 110 forms a film across the thermally insulating layer 120. The porous heating element has advantages as parallel track portion heating elements, described in relation to FIGS. 6 (a) to (c).

In general, failure initiation of a heater track involves an increase of local resistance. In the case of a single narrow track design as found in existing serpentine, a local resistance increase causes more power dissipation, further increasing the resistance until breakage, i.e., positive feedback.

The heater assembly of FIGS. 5 (a) and 5 (b) avoids that effect by allowing the current flow to redistribute and avoid region(s) of increased resistance. Specifically, when a voltage is applied across the heating element, current flows in the heating element as illustrated in FIG. 5 (a). Upon heating under normal (undamaged) condition, the current flows in a parallel manner in the heating element. In the case of damage in the heater film as demonstrated by the defect 108 in FIG. 5 (b), the local resistance in the damaged area increases. This increase in local resistance pushes current away from the damaged area to flow along the path of least resistance, avoiding positive feedback leading to heater failure. As the heater failure is local (unlike for a single narrow heating track), the overall operation of the heater is preserved, and its life span is thus increased.

Referring to FIGS. 6 (a) to 6 (c), there are shown schematic illustrations of different heating elements 110 for an aerosol-generating system. Each heating element 110 comprises a plurality of tracks or track portions 117 arranged electrically in parallel. By being arranged electrically in parallel, current flow is split into separate parallel flow paths. The flow paths are subsequently re-combined.

In the heating elements 110 of FIGS. 6 (a) to 6 (c), each heating element 110 comprises a first connecting pad 113 and a second connecting pad 114. The first and second connecting pads 113, 114 are configured to allow connection to an external circuit. An aperture or plurality of apertures 115 in the heating element 110 separate each track 117. Each heating element 110 comprises a diverging portion, in which current is split from the first connecting pad 113 into tracks 117 which define electrically parallel paths. Each heating element 110 comprises a converging portion, in which current is combined from tracks 117 which define electrically parallel paths, into the second connecting pad 114.

Various different arrangements are possible of tracks or track portions arranged electrically in parallel. In FIG. 6 (a), four tracks 117 are separated by three apertures 115 to define four electrically parallel paths. In FIG. 6 (b), six track portions 117 are separated by one aperture 115 to define two electrically parallel paths. In FIG. 6 (b), each electrically parallel path defines a serpentine path between the first connecting pad 113 and the second connecting pad 114. In FIG. 6 (c), eight track portions 117 are separated by four apertures 115 to define four pairs of electrically parallel paths. Each pair of electrically parallel path in FIG. 6 (c) is separated by an intermediate connection 116, of which three are shown in FIG. 6 (c).

By having tracks or track portions arranged electrically in parallel, if one track portion is defective, current can be redistributed and can still flow through the heating element 110, i.e. the electrical connection between the first connecting pad 113 and the second connecting pad 114 is not broken. This has the advantage of increasing the number of puffs before full failure of the heater, and potentially increasing the heater lifetime up to the lifetime of the device. In contrast, in a simple serpentine heater defining a single electrical path between a first connecting pad 113 and a second connecting pad 114, if a part of the serpentine heating element is broken, then the heating element will stop working due to an increase in local resistance at the breakage or defect point. A defect in a simple serpentine heater causes an increase in local resistance. An increase in local resistance causes increased power dissipation. Increased power dissipation in turn increases the resistance until breakage.

The inventors have also identified that the parallel tracks or track portions arranged electrically in parallel, explained with reference to FIGS. 6 (a) to (c), has a surprising additional advantage. In such an arrangement, in case of breakage of one track portion, the heating element will still operate and can, for an initial transitory period, operate in an advantageous way, because the breakage of one track or track portion would result in a higher energy density on the remaining tracks or track portions. In such a case, the same power would still be provided but on a smaller area, so the throughput would be increased. While such a breakage causing an increase in current on unbroken tracks or track portions can eventually degrade the user experience, the device or cartridge can include a mechanism to alert the user about possible future below optimal performance of the heater assembly.

Such a mechanism relies on the following principles. The total electrical resistance of the heating element depends on the following factors:
1) the number of heating tracks in parallel (more parallel tracks decrease the total resistance);
2) the cross-sectional area (width or thickness (or width and thickness)) of the parallel heating tracks (a higher cross-sectional area leads to a lower resistance);
3) the length of the parallel heating tracks (longer tracks have a higher resistance);
4) if the heating element is porous, tuning the porosity of heating element (higher porosity increases resistance);
5) particular chemical or material composition (e.g. alloys by doping).

The overall total heating element resistance Rₜₒₜ of an arrangement of a number of heating tracks or track portions (i) arranged in parallel such that electric current in at least two neighbouring tracks or track portions flows in the same direction, Rᵢ is set out in equation 4:

$$\frac{1}{{R}_{tot}} = {\sum }_{i}^{n} \frac{1}{{R}_{i}} \qquad ( 4 )$$

where n is the total number of heating tracks arranged electrically in parallel.

The behavior of a parallel track heating element when one heating track fails can be considered with reference to a heating element with 4 parallel heating tracks, for example as shown in FIG. 6(a). The heating tracks each have a resistance of 3 Ohms. The total resistance of the heating element is 0.75 Ohms, calculated using equation 4.

When one heating track starts to fail, the resistance of the failing heating track increases. The total resistance of the heating element also starts to increase, following a linear relationship with the failing heating track resistance. However, as the heating track resistance continues to increase, the heating element resistance asymptotes to a constant resistance value. At this constant resistance value, the influence of the failing heating track on the heating element resistance is capped. In this example where unbroken heating tracks each have a resistance of 3 Ohms, the total resistance of the heating element that asymptotes to 1 Ohm when the failed track can be considered as an open circuit (i.e. no more current can flow through it). When one track breaks in this example, only three tracks remain for the purpose of calculating the total heating element resistance.

To consider the behavior of such a heating element, a supply voltage of 3.5 Volts and target power of 5.5 Watts are considered. In this example, unbroken parallel heating tracks remain with their initial resistance of 3 Ohms. In the failing track, the total maximum current decreases with increasing resistance. In the failing track, current decreases to zero once broken. The current through the unbroken parallel tracks remains substantially constant as the resistance of the failing track increases (if resistance change due to temperature increase is ignored).

A similar behavior is observed for the maximum heating power generation. Less total power is generated once a heating track has failed. However, in this example, the maximum power remains higher than the target of 5.5 Watts despite failure of one of the heating tracks.

In contrast to the heater film depicted schematically in FIGS. 5 (a) and 5 (b), the overall heating element resistance increase of the parallel track heating element can be monitored by control electronics. In a heater film, such as the film of FIGS. 5 (a) and 5 (b), the damaged area 108 may widen with time until failure occurs, because the current density across the heater film (perpendicular to the current flow) increases at the damaged area, generating more power, elevating the local temperature. This locally increases the resistance of the heater film, further increasing the temperature until breakdown (i.e., positive feedback). In the parallel track heating element, in contrast, the overall heating element resistance increase can be monitored by the control electronics. The device or system may be configured such that when a predetermined threshold is reached, the device or system tells the user through a user interface that the heater assembly should be exchanged.

The device or cartridge may also be configured to extend the life of the parallel track heating element. The aerosol-generating device or system may comprise control circuitry. The control circuitry may be configured to, after detecting the failure of a heating track for example by a feedback loop, adjust the power fed to the heater. The control circuitry may be configured to provide a pulse width modulation (“PWM”) signal to control the power fed to the heater. The control circuitry may adjust the power fed to the heater by adjusting the duty cycle of the pulse width modulation signal. In an example, control circuitry may be configured to have a duty cycle at 33.7 percent when the heating tracks are in a normal condition. The duty cycle may increase to 44.9 percent when one of the heating tracks has failed. When one of the heating tracks fails, the power density (heating power generated by surface area) increases, enhancing the thermal efficiency of the heater body. Therefore, the proper operation of the heater is not jeopardized with one failed heating track. A similar result occurs if a second heating track breaks. The control circuitry may be configured such that the duty cycle further increases (to 67.4 percent in the current example). Thus, a heating element with four parallel heating tracks can still operate with the nominal condition of 5.5 Watts even if two of these heating tracks are broken, since the duty cycle remains below 100 percent.

The control circuitry may be configured such that, based on the change of nominal total resistance of the heating element once a parallel heating track has failed, it is possible for the control circuitry to assess the state of the heating element (i.e., number of heating tracks which have failed). The control circuitry may be configured such that, after a predefined number of heating track(s) have failed, the device can tell the user that the heater assembly should be changed.

The heating element of FIGS. 6 (a) to 6 (c) comprises a plurality of tracks or track portions 117 arranged with a distance 118, 119 between at least two of the plurality of tracks or track portions 117 in the range 150 to 300 micrometres. This has the advantage of providing particularly effective heating of the substrate at the heating element 110, while limiting heat losses through the porous body 130.

Referring to FIGS. 7 (a) and 7 (b), there are shown schematic illustrations of current flow 109 around a corner of a heating element track.

FIG. 7 (a) is a schematic illustration of current flow 109 around a known heating element in which a track portion defines a path having a bend, the inner edge of the bend having a sharp corner. In such a track, current flow depicted by arrows 109, which follows a path of least resistance, is concentrated (i.e., there is an increase in current density). This concentration occurs at an inner edge of the corner. Current concentration can increases the local temperature, and can lead to the presence of hot spot at the corner. A hot spot is disadvantageous, as it can affect the efficiency and reliability of the heating element. A hot spot occurs despite the potential for local resistivity of the heater track material to increase due to a local increase in temperature (which would direct current flow away to a path of lower resistance).

FIG. 7 (b) is a schematic illustration of current flow 109 around a heating element in which a track portion 117 defines a path having a bend, the inner edge of the bend being curved. In such a track 117, current flow 109 does not form a local hot spot.

In contrast to the track shape shown in FIG. 7 (a), current flow 109 in the smoother curved track portion 117 as shown in FIG. 7 (b) remains more evenly distributed across the heating track 117, as depicted by dashed arrows 109. Current flow 109 is guided to flow more evenly, to avoid a concentration of current at any point. This in turn limits hot spot creation. The heater track 117 may have a gradient of electrical resistivity perpendicular to current flow in a corner or corners, such that the electrical resistivity is higher at an inner part of the corner and lower at an outer part of the corner. Such a gradient is beneficial to counterbalance localized high current density and reduce hot spot creation.

Referring to FIG. 8, there is shown a heater assembly 200 comprising a heating element 204 for vaporising a liquid aerosol-forming substrate and a porous body 202 for supplying the liquid aerosol-forming substrate from a reservoir or liquid storage portion (not shown) to the heating element. The porous body 202 has a liquid absorption surface (not shown) and a heating surface 202a. The heating element 204 is arranged on the heating surface 202a of the porous body 202.

The heating element 204 is formed from a layer of electrically conductive material such that an electrical current can pass through the heating element 204 to heat the heating element 204 by resistive or Joule heating. The heating element 204 is also porous such that it is fluid permeable and vapours can pass through it from the heating surface 202a of the porous body 202. Therefore, in the heater assembly 200 of FIG. 8, vapour emission occurs through the heating element 204. The heating element 204 may comprise a thin metallic layer or film having pores that pass through the thickness of the layer or film. Alternatively, the heating element may comprise a metallic foam having interconnected open pores that pass through the thickness of the foam. In this example, the porous body 202 comprises a porous ceramic body formed from a suitable ceramic material such as Al₂O₃. Furthermore, the heating element 204 has been deposited on the porous ceramic body 202 using a suitable physical or chemical vapour deposition process.

The heater assembly 200 further comprises electrical contacts 206 that are electrically connected to the heating element. The electrical contacts 206 are arranged on the heating surface 202a and at or near opposite ends of the heating surface 202a. The electrical contacts 206 are arranged on top of the thermally insulating layer, which is disposed between the heating surface 202a and the heating element 204. The heating element 204 extends between the electrical contacts 206. The electrical contacts 206 are arranged to be connected to control circuitry for controlling the supply of electrical power to the heating element. The electrical contacts 206 are formed from a more electrically conductive material than the heating elements such as copper, gold or zinc, although other suitable materials may be used. This avoids excess wasted heat being generated in the electrical contacts.

FIG. 9 shows a schematic cross-sectional view of the heater assembly 200 of FIG. 8. For clarity and simplicity, the features are not drawn to scale. The liquid absorption surface 202b is shown as the lower surface of the porous body 202 in FIG. 9 and the heating surface 202a is shown as the lower surface of the porous body 202, although it will be appreciated that the orientation of these surfaces may differ in use or once the heater assembly 200 is installed in an aerosol-generating device. Liquid stored within a liquid reservoir or liquid storage portion (not shown) contacts the liquid absorption surface 202b and is conveyed through the porous body 202 to the heating surface 202a, as indicated by arrows E in FIG. 9. The porous heating element 204 is arranged on the heating surface 202a of the porous body 202 and heats the liquid aerosol-forming substrate conveyed to it such that the liquid aerosol-forming substrate boils and generates a vapour. The porous heating element 204 has a plurality of pores which pass through the thickness of the heating element from the heating surface 202a to an exterior of the heater assembly 200.

Since the heating element 204 is porous, vapour generated during heating of the heating element 204 can pass through the heating element 204 via the pores and be emitted from the heating surface 202a, as indicated by arrows F in FIG. 9. The heating element does not have any impermeable sections which prevent vapour release and cause a build up of vapour pressure underneath the heating element. This reduces the speed of vapour emission from the heating element 204 compared to conventional impermeable track heating elements. Simulations have demonstrated that an average vapour emission speed of the vapour from the heating surface 202a is 0.1 metres per second at a power of 6.3 watts. Such a low vapour emission speed means that the vapour can easily be carried away by the airflow in an airflow pathway without impinging on the internal walls of the airflow pathway and causing condensation. As indicated by arrows F, the average vapour emission direction is substantially perpendicular to the heating surface 202a of the porous body 202 and vapour is emitted consistently across the surface of the heating element.

FIG. 10 is a schematic illustration of the interior of an aerosol-generating system 800 according to an example of the present disclosure. The aerosol-generating system 800 comprises two main components, a cartridge 801 and a main body part or aerosol-generating device 900. The cartridge 801 is removably connected to the aerosol-generating device 900. The aerosol-generating device 900 comprises a device housing 901 that contains a power supply in the form of a battery 902, which in this example is a rechargeable lithium ion battery, and control circuitry 903. The aerosol-generating system 800 is portable and has a size comparable to a conventional cigar or cigarette. A mouthpiece is arranged at a mouth end of the cartridge 801.

The cartridge 801 comprises a cartridge housing containing a heater assembly 100 and a liquid reservoir or liquid storage portion 803 for holding a liquid aerosol-forming substrate. Liquid aerosol-forming substrate is conveyed downwards from the liquid absorption surface 134 through the porous body to the heating element and vaporised aerosol-forming substrate is emitted from the heating surface 133 when electrical power is supplied to the heating element.

The cartridge 801 comprises one or more air inlets 804 formed in the cartridge housing 805 at a location along the length of the cartridge 801. An aerosol outlet 806 is located in the mouthpiece at the mouth end of the cartridge 801. The one or more air inlets 804 are in fluid communication with the aerosol outlet 806 to define an airflow pathway through the cartridge 801 of the aerosol-generating system 800. The airflow pathway flows from the one or more air inlets 804 to the heater assembly 100 in an airflow channel. The heater assembly 100 is arranged in fluid communication with the airflow pathway in the airflow channel. Air enters the one or more air inlets 804 and flows through the airflow channel past the heater assembly 100 in an average airflow direction.

In the example of FIG. 10, the liquid storage portion 803 is annular in cross-section and is arranged around a central sealed aerosol channel 807. Once the airflow pathway reaches the heater assembly 100, it is diverted upwards around the sides of the heater assembly 100 and flows through the aerosol channel 807 to the aerosol outlet 806.

The aerosol-generating system 800 is configured so that a user can puff or draw on the mouthpiece of the cartridge to draw aerosol into their mouth through the aerosol outlet 806. In operation, when a user puffs on the mouthpiece, air is drawn in through the one or more air inlets 804, along the airflow pathway through the airflow channel, past and around the heater assembly 100 and along the airflow pathway through the aerosol channel 807 to the aerosol outlet 806. The control circuitry 903 controls the supply of electrical power from the battery 902 to the cartridge 801 when the system is activated. This in turn controls the amount and properties of the vapour produced by the heater assembly 100. The control circuitry 903 includes an airflow sensor (not shown) and supplies electrical power to the heater assembly 100 when user puffs are detected by the airflow sensor. This type of control arrangement is well established in aerosol-generating systems such as inhalers and e-cigarettes. When a user puffs on the mouthpiece of the cartridge 801, the heater assembly 100 is activated and generates a vapour that is entrained in the airflow pathway. The vapour cools within the airflow pathway to form an aerosol, which is then drawn into the user's mouth through the aerosol outlet 806.

FIG. 11 is a schematic cross-sectional view of part of an aerosol-generating system 300 according to another example of the present disclosure showing an arrangement of a heater assembly 300 relative to an airflow pathway 320 within the aerosol-generating system 300. For simplicity, other components of the aerosol-generating system have been omitted from FIG. 11. The heater assembly 200 of FIG. 11 is identical to the heater assemblies 200 of FIGS. 8 and 9. The aerosol-generating system 300 comprises a liquid storage portion 322 that holds a liquid aerosol-forming substrate in contact with the liquid absorption surface 202b of the porous body 202. Liquid aerosol-forming substrate is conveyed from the liquid storage portion 322 through the porous body 202 to the heating surface 202a, as indicated by arrows E. Vaporised aerosol-forming substrate is emitted through the porous heating element 204 from the heating surface 202a. As indicated by arrows F, the average vapour emission direction is substantially perpendicular to the heating surface 202a of the porous body 202.

In the example of FIG. 11, the heater assembly 200 is arranged below or to one side of the airflow channel or pathway 320, which airflow pathway 320 is defined by airflow channel walls 324. As viewed in FIG. 11, a left-hand end of the visible portion of the airflow pathway 320 receives airflow from an air inlet (not shown) and the right-hand end of the visible portion of the airflow pathway delivers airflow to an aerosol outlet (not shown). The heating surface 202a of the porous body 202 is arranged parallel to the airflow pathway 320 and faces into the airflow pathway 320. The heater assembly 200 is in fluid communication with the airflow pathway such that the airflow in the airflow pathway flows past the heater assembly 200 in an average airflow direction, as indicated by arrows G. The heater assembly 200 and airflow pathway 320 are arranged such that an angle θ between the average vapour emission direction F and the average airflow direction G is approximately 90 degrees, that is, at an angle θ substantially perpendicular to the average airflow direction G. The average vapour emission direction F has no speed or direction component that opposes the average airflow direction G and therefore any loss of momentum of the airflow is reduced. This reduces the tendency for recirculation and turbulence to occur in the airflow path 320 and the vapour is less likely to impinge on the internal surfaces of the airflow channel walls 324.

FIG. 12 is a schematic cross-sectional view of part of an aerosol-generating system 400 according to another example of the present disclosure showing another arrangement of a heater assembly 200 relative to an airflow pathway 420 within the aerosol-generating system 400. For simplicity, other components of the aerosol-generating system have been omitted from FIG. 12. The heater assembly 200 of FIG. 12 is identical to the heater assemblies 200 of FIGS. 8 and 9. The aerosol-generating system 400 comprises a liquid storage portion 422 that holds a liquid aerosol-forming substrate in contact with the liquid absorption surface 202b of the porous body 202. Liquid aerosol-forming substrate is conveyed from the liquid storage portion 422 through the porous body 202 to the heating surface 202a, as indicated by arrows E. Vaporised aerosol-forming substrate is emitted through the porous heating element 204 from the heating surface 202a. As indicated by arrows F, the average vapour emission direction is substantially perpendicular to the heating surface 202a of the porous body 202.

In the example of FIG. 12, the airflow channel or pathway 420 is split into first and second airflow pathway sections 420a and 420b which pass either side of the heater assembly 200. The first and second airflow pathway sections 420a and 420b combine downstream of the heater assembly 200 into a third airflow pathway section 420c. The first and second airflow pathway sections 420a and 420b receive airflow from one or more air inlets (not shown) and the third airflow pathway section 420c delivers airflow to an aerosol outlet (not shown). The airflow pathway 420 is defined by airflow channel walls 424. The heating surface 202a of the porous body 202 is arranged substantially perpendicular to the airflow pathway 420 and faces in a downstream direction of the airflow pathway 420. The heater assembly 200 is in fluid communication with the airflow pathway such that the airflow in the airflow pathway flows past the heater assembly 200 in an average airflow direction, as indicated by arrows G.

The heater assembly 200 and airflow pathway 220 are arranged such that an angle θ between the average vapour emission direction F and the average airflow direction G is less than 90 degrees. Upstream of the heating surface 202a of the porous body 202, the average airflow direction G past the heater assembly 200 is substantially the same as the vapour emission direction F. At the point along the airflow pathway 420 corresponding to the heating surface 202a the airflow pathway 420 starts to narrow or taper inwards, at which point the average airflow direction G past the heater assembly 200 changes to an angle θ relative to the vapour emission direction F of approximately 45 degrees. Downstream of the heating surface 202a of the porous body 202 in the third airflow pathway section 420c, the average airflow direction G of the combined airflow is again substantially the same as the vapour emission direction F. It will be appreciated that the narrowing or tapering of the airflow pathway 420 could be omitted. In which case, the average airflow direction G past the heater assembly 100 would be substantially the same as the vapour emission direction F.

FIGS. 13 and 14 show a schematic illustration of an example of a heater assembly 500 for an aerosol-generating system. The heater assembly includes a heating element 510 and a porous body 520.

The heating element 510 is configured to vaporise an aerosol-forming substrate, such as a liquid aerosol-forming substrate, to form an aerosol. The heating element 510 is configured to convert electrical energy into heat energy by material resistance of the heating element 510 to an electrical current.

The porous body 520 is configured to convey the liquid aerosol-forming substrate to the heating element 510. In other words, the porous body 520 supplies the liquid aerosol-forming substrate to the heating element 510.

The porous body 520 has a first end face and an opposing second end face. The first end face is a liquid absorption surface 530 and the second end face is a heating surface 540. In this example, the liquid absorption surface 530 and the heating surface 540 are both substantially flat surfaces. The porous body 520 also has a plurality of lateral faces extending between the liquid absorption surface 530 and the heating surface 540.

In this example, as will be discussed in more detail below, the porous body 520 has a first lateral face 550 opposing a second lateral face 560, and a third lateral face 570 opposing a fourth lateral face 580.

The porous body 520 comprises a plurality of pores. The plurality of pores are interconnected to provide a fluid pathway for liquid aerosol-forming substrate through the porous body 520, from the liquid absorption surface 530 to the heating surface 140. The porous body 520 is formed from a material that does not chemically interact with the liquid aerosol-forming substrate. In this example, the porous body 520 is a porous ceramic body and may be formed from, for example, Ca₂SiO₃ or SiO₂ (or Ca₂SiO₃ and SiO₂). In another example, the porous body 520 may be, for example, a porous glass body.

The heating element 510 is located on the thermally insulating layer 590, on the porous body 520. In the example of FIGS. 13 and 14, the heating element 510 is a porous film that extends across substantially all of the heating surface 540.

The liquid absorption surface 530 of the porous body 520 has an area that is different to an area of the heating surface 540 of the porous body 520. Specifically, in the example of FIGS. 13 and 14, the area of the heating surface 540 is less than the area of the liquid absorption surface 530.

In the example of FIGS. 13 and 14, the heating surface 540 has smaller area than the liquid absorption surface 530 because the length of the heating surface 540 is less than the length of the liquid absorption surface 530. In addition, or alternatively, in another example, the heating surface 540 may have a smaller area than the liquid absorption surface 530 because the width of the heating surface 540 is less than the width of the liquid absorption surface 530.

In the example of FIGS. 13 and 14, the porous body 520 is shaped as a trapezoid prism. With the porous body 520 having a trapezoid prism shape, the first lateral face 550 and the second lateral face 560 both have a trapezium shape, specifically an isosceles trapezoid, the third lateral face 570 and the fourth lateral face 580 both have a rectangle shape, and the liquid absorption surface 530 and the heating surface 540 both have a rectangle shape. In another example, the liquid absorption surface 530 and the heating surface 540 may have a square shape.

The porous body 520 tapers from the liquid absorption surface 530 towards the heating surface 540. In other words, the cross-sectional area of the porous body 520 gradually becomes smaller from the liquid absorption surface 530 towards the heating surface 540. In the example of FIGS. 13 and 14, the length of the porous body 520 decreases from the liquid absorption surface 530 towards the heating surface 540 which causes the tapering.

The heater assembly 500 includes a thermally insulating layer 590.

The heating element 510 is arranged along a heating surface of the thermally insulating layer 590. The heating element 510 is in direct contact with the thermally insulating layer 590.

The thermally insulating layer 590 is arranged to enhance thermal insulation between the heating element 510 and the porous ceramic body 520. The thermally insulating layer 590 is arranged to extend across at least a portion of the heating element 510 to thermally insulate the heating element 510 from the porous ceramic body 520. The thermally insulating layer 590 is configured to reduce heat dissipation through the porous ceramic body 520, so as to enhance energy efficiency by reducing energy losses.

FIG. 15 shows a heater assembly 600 for use in an aerosol-generating system. The heater assembly 600 comprises a heating element 610 for vaporising a liquid aerosol-forming substrate. The heater assembly 600 also comprises a porous ceramic body 620 for conveying the liquid aerosol-forming substrate to the heating element 610. The porous ceramic body 620 has a liquid absorption surface 621 and an opposed heating surface 622. The heating element 610 is located on a thermally insulating layer 630. The thermally insulating layer 630 is located on the heating surface 622 of the porous ceramic body 620.

The heating surface 622 of the porous ceramic body 620 is curved. In particular, the heating surface 622 of the porous ceramic body 620 is convexly curved in a single transverse direction (the first transverse direction).

The porous body 620 is prismatic in shape. When viewing a longitudinal cross-section perpendicular to the direction of curvature of the porous body 620, the heating surface 622 of the porous body 620 is shown as arc. The porous body 620 has two longitudinal planes of symmetry.

The heating surface 620 of the porous ceramic body 620 has a width 623 in the first transverse direction substantially the same as the width of the porous ceramic body 620 in the first transverse direction, and substantially the same as the width of the heater assembly 600 in the first transverse direction. The heating surface 620 of the porous ceramic body 620 has a width of about 5 millimetres in the first transverse direction.

The heating surface 620 of the porous ceramic body 620 has a length or thickness 124 of about 1 millimetre. The porous ceramic body 620 has a length or thickness of about 3 millimetres.

The heating surface 620 of the porous ceramic body has a radius of curvature of about 3.6 millimetres. The heating surface 620 of the porous ceramic body has a surface area of about 28 square millimetres.

The porous body 620 comprises four longitudinal surfaces or side walls extending from the liquid absorption surface 621 to the heating surface 622. The four side walls are substantially perpendicular to the liquid absorption surface 621, which is substantially flat. The liquid absorption surface 621 is square in shape.

The heating element 610 is a resistive heating element 610.

The heating element 610 is curved. In particular, the curvature of the heating element is substantially the same as the curvature of the heating surface 622 of the porous ceramic body 120. As such, the heating element 610 is also convexly curved in a single transverse direction.

The heating element 610 is located directly on the heating surface 622 of the porous ceramic body 620. The heating element 610 extends across a majority of the heating surface 622 of the porous ceramic body 620. Substantially the entirety of the heating element 610 is in contact with the heating surface 622 of the porous ceramic body 620.

The heater assembly 600 comprises a thermally insulating layer 630 located between the porous ceramic body 620 and the heating element 610. The thermally insulating layer 630 is in direct contact with both the heating surface 622 of the porous ceramic body 620 and the heating element 610. The thermally insulating layer 620 substantially covers the entirety of the heating surface 622 of the porous ceramic body 620.

The thermally insulating layer 630 is arranged to enhance thermal insulation between the heating element 610 and the porous ceramic body 620. The thermally insulating layer 630 is configured to reduce heat dissipation through the porous ceramic body 620, so as to enhance energy efficiency of the heater assembly 600 by reducing energy losses.

The thermally insulating layer 630 is curved. In particular, the thermally insulating layer 630 is convexly curved in a single transverse direction (the first transverse direction). The curvature of the thermally insulating layer 630 corresponds to the curvature of the heating surface 622 of the porous ceramic body 620.

In particular, the thermally insulating layer 620 has a first end face and an opposing second end face. The first end face is a liquid absorption surface 631 and the second end face is a heating surface 632. Both the liquid absorption surface 631 of the thermally insulating layer 630 and the heating surface 632 of the thermally insulating layer are convexly curved in the first transverse direction with the curvature thereof corresponding to the curvature of the heating surface 622 of the porous ceramic body 620.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent (10%) of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. A heater assembly for an aerosol-generating device, the heater assembly comprising:
a heating element configured to vaporise a liquid aerosol-forming substrate;
a porous body configured to convey the liquid aerosol-forming substrate to the heating element; and
a thermally insulating layer having a lower thermal conductivity than the porous body, wherein the thermally insulating layer is disposed between and is in contact with each of the porous body and the heating element, and the thermally insulating layer is configured to reduce heat transfer from the heating element to the porous body,
wherein the porous body comprises a porous ceramic body or a porous glass body, and
wherein the heating element forms a film across the thermally insulating layer.

17. The heater assembly according to claim 16, wherein the thermally insulating layer comprises a thermally insulating material, the thermally insulating material having a lower thermal conductivity than the porous body.

18. The heater assembly according to claim 16, wherein the thermally insulating layer comprises a material having a thermal conductivity of less than 40 Watts per metre-Kelvin.

19. The heater assembly according to claim 16, wherein the thermally insulating layer comprises a material having a thermal conductivity of less than 10 Watts per metre-Kelvin.

20. The heater assembly according to claim 16, wherein the thermally insulating layer comprises a thermally insulating material, the thermally insulating material having a higher porosity than the porous body.

21. The heater assembly according to claim 16, wherein the thermally insulating layer extends entirely between the porous body and the heating element.

22. The heater assembly according to claim 16, wherein the thermally insulating layer comprises one or more of: alumina, zirconia, zirconia with magnesium oxide, glass ceramic, quartz, a porous polymer.

23. The heater assembly according to claim 16, wherein the thermally insulating layer has a thickness of between 0.1 mm and 2 mm.

24. The heater assembly according to claim 16, wherein the thermally insulating layer has a thickness of between 0.5 mm and 1.5 mm.

25. The heater assembly according to claim 16, wherein the heating element is a porous heating element.

26. The heater assembly according to claim 16, wherein the thermally insulating layer has a heating surface, and the heating element extends to cover an area of the heating surface of the thermally insulating layer.

27. The heater assembly according to claim 16, wherein the heating element comprises a plurality of tracks or track portions arranged with a distance between at least two of the plurality of tracks or track portions in a range of 150 micrometres to 300 micrometres.

28. The heater assembly according to claim 16, wherein the porous body comprises an electrically insulating material.

29. The heater assembly according to claim 16, wherein the heating element and the porous body are integrally formed.

30. The heater assembly according to claim 16, wherein the thermally insulating layer has a heating surface, and the heating element is located on and bonded to the heating surface of the thermally insulating layer.

31. An aerosol-generating system, comprising:
the heater assembly according to claim 16, wherein the heating element is fluid-permeable such that vapour is emitted from the heater assembly in an average vapour emission direction; and
an air inlet and an aerosol outlet, the air inlet being in fluid communication with the aerosol outlet to define an airflow pathway through the aerosol-generating system,
wherein the heater assembly is arranged in fluid communication with the airflow pathway such that air flows past the heater assembly in an average airflow direction, and
wherein the heater assembly and airflow pathway are arranged such that an angle between an average vapour emission direction and an average airflow direction is less than 135 degrees.
